(19) United States
(12) Patent Application Publication
(10) Pub. No.: US 2012/0058269 A1
(43) Pub. Date: Mar. 8, 2012

(54) Apparatus, System, and Method for Creating Spin-Art on Fabric

(75) Inventors: Donald James MacFadyen, Monrovia, MD (US); David Jerry MacFadyen, Angola, IN (US)

(73) Assignee: SOCO, LLC, Frederick, MD (US)

(21) Appl. No.: 13/224,521

(22) Filed: Sep. 2, 2011

Related U.S. Application Data
(60) Provisional application No. 61/379,460, filed on Sep. 2, 2010.

(51) Int. Cl. B05C 13/02; B05D 3/12

(52) U.S. Cl. 427/240; 118/52

(57) ABSTRACT

A system, apparatus, and method for creating designs on an underlying material by spinning a platform on which the material is positioned while applying a coloring agent onto the material, and a system and method for lifting and disassembling a spinning platform to remove the painted material.

### CROSS-REFERENCE TO RELATED APPLICATIONS

This application is an International Application, which claims priority to and the benefit of U.S. Provisional Application No. 61/379,460 filed on Sep. 2, 2010, the content of which is incorporated herein by reference in its entirety.

### BACKGROUND OF THE INVENTION

The present invention relates generally to painting devices, systems and methods, and more particularly to spin-art devices, systems and methods. Spin-art generally refers to depositing radial paint patterns on a material surface. To produce spin-art, a platform on which the material is deposited is spun so that the paint, which is applied on a surface of the material, radially spreads across the material surface under the action of a centrifugal force.

### SUMMARY

In various embodiments a system and method for creating different design patterns on a fabric by applying paint to the fabric while the fabric is spun in a spinning assembly is disclosed.

In various embodiments a method and apparatus for creating wearable art on articles of clothing is disclosed.

In various embodiments a spinning device for creating spin art on articles of clothing is disclosed.

In various embodiments a spinning device is disclosed for creating art work on a material such as, but not limited to, a fabric, for example. The spinning device includes a housing having a base portion (for example, a base unit) and a substantially vertical portion having a cylindrical shape and formed integral with the base portion, the vertical portion having an opening therethrough so as to expose a rotatable carrier assembly (for example, a plunger and saucer) on which the material is mounted. The spinning device further includes a rotatable member (for example, a driver) positioned within the vertical portion, the rotatable member being detachably attached to the base portion and configured to engage and rotate the carrier assembly about a spinning axis to allow a coloring agent applied to the material to spread under the action of a centrifugal force.

In various embodiments the base portion includes a plurality of recesses (for example, cavities, indentations, dents, depressions, sinks, dips, etc.) in an upper surface thereof (i.e., a top), the recesses being configured to receive, respectively, a rotating mechanism, and one or more power sources.

In various embodiments the rotating mechanism includes a motor and a motor shaft positioned in one of the recesses. The rotating mechanism can further include a securing member (for example, a receiver) attached to the motor shaft to engage the rotatable member. The motor can be connected to one or more power sources which are received within the remaining recesses.

In various embodiments the spinning device further includes a cover member, such as, but not limited to, a motor plate, to cover the recess that contains the motor and the motor shaft. The motor plate is positioned on the recess so as to be flush with the upper surface of the base portion. The motor plate also includes an opening through which the receiver engages the driver. The driver is detachably attached to the base portion via the receiver. The receiver is configured to secure a close fit with the driver.

In various embodiments the one or more power sources are batteries positioned in respective recesses.

In various embodiments the spinning device further includes a plurality of cover members to cover the upper surfaces of the recesses containing the batteries. The battery cover members can be positioned so as to be flush with the upper surface of the base portion.

In various embodiments the spinning device can include a switch to activate the motor by an external cord (hand-held or foot-pedal switch, for example) so that a user can turn the motor on and off from the outside.

In various embodiments the motor can be activated remotely.

In various embodiments the carrier assembly includes a substantially disc-like platform (for example, a carrier, a saucer) over which the material is stretched, and a substantially plate-like platform (for example, the plunger) which, when pushed against the saucer, holds the material stretched and in place.

In various embodiments the plunger can include flexible finger-like spiral members to act like springs to clamp the material in place. The finger-like spiral members also apply pressure to the inside of the saucer to provide friction between the saucer and the plunger so that together the saucer and the plunger provide a secure material holding assembly and so that the saucer and the plunger rotate together as a unit during spinning. The plunger is further configured to keep the saucer from detaching (i.e., climbing off, moving away) from the plunger during spinning. Various friction enhancing elements can also be used, including adding ridges and/or detents to the inner surface of the saucer, to increase friction between the saucer and the plunger.

In various embodiments the plunger further includes an opening on an upper surface thereof as well as an elongated funnel-like connecting member formed integrally with the upper surface of the plunger so that a conduit is established through the plunger. A continuous dimple (for example, an indent) positioned around the plunger opening can also be added to allow a snug fit of the plunger against the saucer cavity.

In various embodiments the saucer includes a substantially disc-like surface and a substantially circular side skirt positioned around the periphery of the disc-like surface to form a cavity underneath the surface. The side skirt can be formed integral with the disc-like surface and can further include an indent along its perimeter. The side skirt can also include a plurality of grooves positioned at predetermined distances along the length of the side skirt so as to separate the side skirt into a plurality of flexible side skirt sections and thereby increase the skirt's overall flexibility.

In various embodiments the saucer also includes an integrally formed elongated funnel-like connecting member in the saucer cavity to establish a conduit through the saucer. The connecting member can be configured to fit through the opening on the upper surface of the plunger and slide through the plunger connecting member in order to engage the driver through the plunger conduit. The saucer connecting member is slightly longer than the plunger connecting member so that a portion of the saucer connecting member sticks out from the plunger connecting member when the saucer and the plunger are fit together.

In various embodiments the driver is configured to be snugly received by the saucer connecting member.

In various embodiments the inside surface of the rotatable member includes a plurality of ridges (i.e., corrugations) and the outside surface of the saucer connecting member includes corresponding ridges (i.e., corrugations) so that after engagement with each other the driver and the carrier assembly spin together as a unit.

In various embodiments the housing has a shape that can contain the coloring agent (e.g., paint) to an inside of the device during spinning.

In various embodiments the spinning device further includes a disposable liner positioned around the inside surface of the cylindrical portion of the housing to protect the inside of the housing from being splashed with the coloring agent during spinning. The liner may have a cylindrical shape that fits snugly within the interior of the cylindrical portion of the housing. The disposable liner may be removed from the housing after the spinning is completed and the coloring agent can be washed off before the liner is reused in another spinning cycle.

In various embodiments the housing can include a mounting bracket on an upper surface of the cylindrical portion, and a lid member pivotably mounted to the mounting bracket and configured to be pivoted between an open position and a closed position so that, in use, the lid member is in a closed position to protect the user from being splashed with the coloring agent. In various embodiments, the lid member can include a generally cylindrical portion with an opening therethrough so that the coloring agent can be applied to the material through the opening when the lid member is in the closed position. In various embodiments the opening in the lid member has a diameter approximately the same as the diameter of the carrier assembly to allow application of the coloring agent onto the material during the spinning. In various embodiments the lid member has a shape that can contain the coloring agent to an inside of the device during spinning.

In various embodiments the base portion further includes multiple protruding members acting as supporting legs integrally formed with the base portion and shaped so as to provide stability to the spinning device during spinning.

In various embodiments the base portion further includes a plurality of receptacles (for example, pockets) formed integral with the base portion and configured to hold containers (for example, bottles) containing coloring agents.

In various embodiments the spinning device further includes one or more lighting devices positioned inside and/or on an outside portion of the housing.

In various embodiments the spinning device further includes music playing devices and various other music playing accessories positioned inside and/or on an outside portion of the housing.

In various embodiments the spinning device is used to create a design pattern on a material which is used for an article of clothing, such as but not limited to, T-shirts, caps, pants, skirts, other headwear, etc.

In various embodiments the spinning device can further include a drying mechanism to dry the coloring agent after the spinning is done and the design is created on the material. In various other embodiments, the drying mechanism can be located outside of the spinning device and can include one or more drying cords on which the material is hung after it is removed from the carrier assembly.

In various embodiments the material is a material used for an article of clothing, such as, but not limited to, T-shirts, caps, pants, skirts, other headwear, etc.

In various embodiments a lifting device is disclosed to disengage the carrier assembly from the driver and remove the carrier assembly from the spinning device. The lifting device is configured to remove the carrier assembly from the spinning device without touching the wet paint on the material and without the material touching the inside of the housing and/or the disposable liner inside the housing.

In various embodiments the lifting device includes a plurality of arm members (for example, hooks) detachably attached to each other at one end and with slightly inward bent free ends at the other end to form a claw shaped lifting mechanism. The free ends are bent just enough to securely hold the bottom edge of the saucer during the lifting. The arm members are connected in such a manner as to allow at least one of the arm members to move freely in a vertical direction relative to the other arm members to make it easier to hook the bottom edge of the saucer without moving the material positioned on the carrier assembly.

In various embodiments a lifting device is disclosed to disengage the carrier assembly from the driver. The lifting device can include one or more movable members positioned inside the vertical member of the housing and detachably attached (i.e., removably connected) to the upper surface of the base portion so as to be substantially perpendicular to the upper surface of the base portion and so as to extend along a direction which is parallel with an axis of rotation of the driver. The one or more movable members can extend to a height just below the plunger so that during the spinning of the carrier assembly the plunger or any other part of the carrier assembly does not touch the one or more movable members. The one or more movable members are further configured to move up and down along a direction parallel to the axis of rotation of the driver so that after the carrier assembly is done spinning, the one or more movable members can be moved in an upward direction to touch a bottom surface of the plunger at one or more locations and to ultimately move the carrier assembly in an upward direction away from the driver and detach the carrier assembly from the driver.

In various embodiments the upper portions of the one or more movable members are shaped so as to safely hold the carrier assembly after the carrier assembly is detached from the driver.

In various embodiments the upper portions of the one or more movable members are shaped so as to snugly fit into one or more apertures located on the bottom surface of the plunger and to safely hold the carrier assembly after the carrier assembly is detached and moved away from the driver.

In various embodiments the one or more movable members can be telescopic rods.

In various embodiments the one or more movable members can be connected to a moving mechanism which when activated allows for the one or more moving members to move up and/or down. The moving mechanism can include a switch button which when turned to an ON position activates the moving mechanism and/or a pedal-like mechanism that when pushed moves the one or more movable members up toward the bottom of the plunger.

In various embodiments a disassembling device is disclosed to disassemble the carrier assembly after is has been lifted out of the spinning machine. The disassembling device is further configured to separate the saucer from the plunger without smudging the wet paint on the material.

In various embodiments the disassembling device includes a substantially circular base member and a substantially cylindrical vertical member attached to the base member and configured to securely hold the carrier assembly.

In various embodiments the top portion of the cylindrical member is shaped so as to allow the saucer connecting member to slide inside the cylindrical member until the top portion of the cylindrical member fits between the saucer connecting member and the plunger connecting member.

In various embodiments the separating of the saucer from the plunger is done by first unhooking the bent end of the movable arm member from the bottom edge of the saucer to detach the lifting device from the carrier assembly and to remove the lifting device from the carrier assembly followed by pulling the plunger in a downward direction on the cylindrical member and away from the saucer until portions of the painted material freely hang from the saucer.

In various embodiments the pulling of the plunger downward to separate the saucer from the plunger is done manually.

In various embodiments the separating of the saucer from the plunger is done by pulling on the plunger connecting member in a downward direction on the cylindrical member of the disassembling device until the material is freely hanging from the saucer.

In various embodiments a method of creating a design on a material by spreading a coloring agent applied to the material under the action of a centrifugal force is disclosed. The method can include positioning the material on a rotatable carrier assembly with a surface of the material being exposed for viewing and another surface being used for securing the material so as to stay stationary relative to a carrier assembly during spinning, spinning the carrier assembly around a spinning axis, and applying the coloring agent onto the exposed surface of the material during the spinning.

In various embodiments the material on which the coloring agent is applied to form a design is an article of clothing, such as, but not limited to T-shirts, skirts, caps, hats, other headwear, etc.

In various embodiments the method can further include a drying step in which the coloring agent is dried.

In various other embodiments the drying step can include drying the material on a drying cord positioned outside of the spinning device or in a drying oven positioned outside of the spinning device.

In various embodiments a method of removing the carrier assembly from the spinning device is disclosed. The method includes attaching a lifting device to the carrier assembly after the carrier assembly stops spinning and lifting the carrier assembly so as to disengage the carrier assembly from the driver.

In various embodiments the lifting device includes a plurality of arm members (hooks) detachably attached to each other at one end and with slightly inward bent free ends at the other end which together form a claw shaped lifting mechanism. The free ends are bent just enough to securely hold the bottom edge of the saucer during the lifting.

In various embodiments a method for detaching the carrier assembly from the driver is disclosed. The method includes activating a moving device to move one or more moving (i.e., telescoping) members detachably attached to the base portion of the spinning device housing toward a bottom portion of the plunger in the carrier assembly and lifting the carrier assembly.

In various embodiments a method of disassembling the carrier assembly is disclosed, the method including positioning the carrier assembly on a disassembling device and manually separating the saucer from the plunger by pulling the plunger in a downward direction away from the saucer. The pulling away of the plunger from the saucer effectively separates the saucer from the plunger.

In various embodiments the disassembling device includes a substantially circular base member and a substantially cylindrical member configured to securely hold the carrier assembly.

In various embodiments the top portion of the cylindrical member is shaped so as to fit between the saucer connecting member and the plunger connecting member.

In various embodiments the top portion of the cylindrical member is shaped so that the saucer connecting member slides inside the cylindrical member until the top portion of the cylindrical member snugly fits in between the saucer connecting member and the plunger connecting member.

In various embodiments the separating of the saucer from the plunger is done by moving the plunger away from the saucer by pulling on the plunger connecting member until the material is freely hanging from the saucer.

### BRIEF DESCRIPTION OF THE DRAWINGS

FIG. 1 is a top perspective view of a spinning device with a piece of material securely fastened on a rotatable carrier assembly, in accordance with an embodiment of the invention.

FIG. 2 is an exploded view of a spinning device, in accordance with an embodiment of the invention.

FIGS. 3A-3D are different views showing the housing of the spinning device shown in FIG. 2, in accordance with an embodiment of the invention.

FIGS. 4-6 are side, top and bottom perspective views, respectively, of a housing of the spinning device shown in FIG. 2, in accordance with an embodiment of the invention.

FIGS. 7-8 are different views of a motor plate that can be used in the spinning device shown in FIG. 2, in accordance with an embodiment of the invention.

FIGS. 9-10 are top and bottom perspective views of a battery cover that can be used in the spinning device as shown in FIG. 2, in accordance with an embodiment of the invention.

FIGS. 11-14 are different views of a rotating member (driver) that can be used in the spinning device shown in FIG. 2, in accordance with an embodiment of the invention.

FIGS. 15-18 are different views of a dimpled plunger that can be used in the spinning device shown in FIG. 2, in accordance with an embodiment of the invention.

FIGS. 19-24 are different views of a saucer that can be used in the spinning device shown in FIG. 2, in accordance with an embodiment of the invention.

FIG. 25 shows a spinning device with a saucer and a dimpled plunger on the side and with a switch to turn the spinning device on and off, in accordance with an embodiment of the invention.

FIG. 26 shows the material being prepared to be tucked in the cavity of the saucer shown in FIG. 25, in accordance with an embodiment of the invention.

FIG. 27 shows the material almost totally tucked in the saucer cavity shown in FIG. 26, in accordance with an embodiment of the invention.

FIGS. 28-29 show the plunger shown in FIG. 26 being fit into the saucer cavity shown in FIG. 27, in accordance with an embodiment of the invention.

FIG. 30 shows a carrier assembly including the saucer and the plunger shown in FIG. 29 being attached to the driver shown in FIG. 26, in accordance with an embodiment of the invention.

FIG. 31 shows a spinning device in use, in accordance with an embodiment of the invention.

FIG. 32 is a view of a disposable liner that can be used in a spinning device shown in FIG. 2, in accordance with an embodiment of the invention.

FIG. 33 shows a T-shirt with a design obtained using the spinning device shown in FIG. 2, in accordance with an embodiment of the invention.

FIG. 34 is a perspective view of a disassembling device together with a carrier assembly lifting device, in accordance with an embodiment of the invention.

FIG. 35 is a cross-sectional view along line A-A of the disassembling device as shown in FIG. 34, in accordance with an embodiment of the invention.

### DETAILED DESCRIPTION

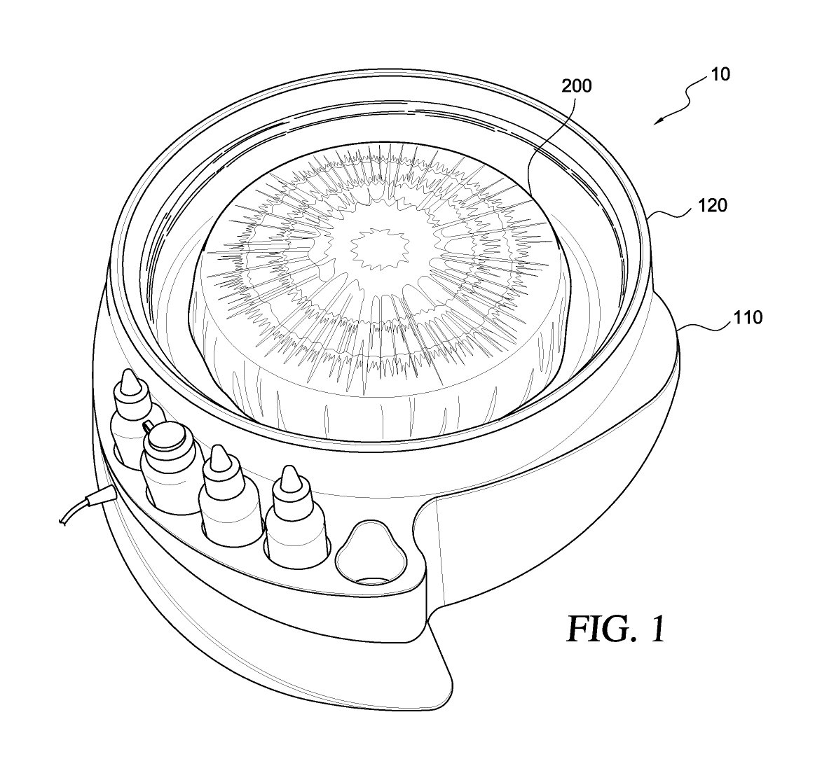

FIG. 1 shows a spinning device (machine, system, assembly) 10 for creating different paint design patterns on a material, such as but not limited to, different fabrics, different canvases, etc, used for an article of clothing, such as T-shirts, caps, headwear, hats, skirts, etc. . . . The spinning device 10 shown in FIG. 1 includes (i.e., comprises) a substantially cylindrically shaped housing 100 having a substantially cylindrical base portion 110 and a generally cylindrical vertical portion 120 extending substantially perpendicularly upward from an upper surface 111 of the base portion 110, and a rotatable carrier assembly (i.e., material holding device or mechanism) 200 mounted on a rotatable member (for example, a driver) (not shown) and positioned within the generally vertical portion 120 of the housing 100. The vertical portion 120 which extends upwardly from the upper surface 111 of the base portion 110 defines an axially aligned open ended channel through which the coloring agent is applied onto the material positioned on the rotatable carrier assembly 200 holding the material. The patterns shown on the material in FIG. 1 are created by applying different coloring agents onto the material while the material is being spun on the rotatable carrier assembly 200. The coloring agent may include any flowable artistic material capable of dispersing across the material under the action of a centrifugal force generated through the rotation of the carrier assembly. Coloring agents may include, but are not limited to, different paints, stains, dyes, chalks, for example.

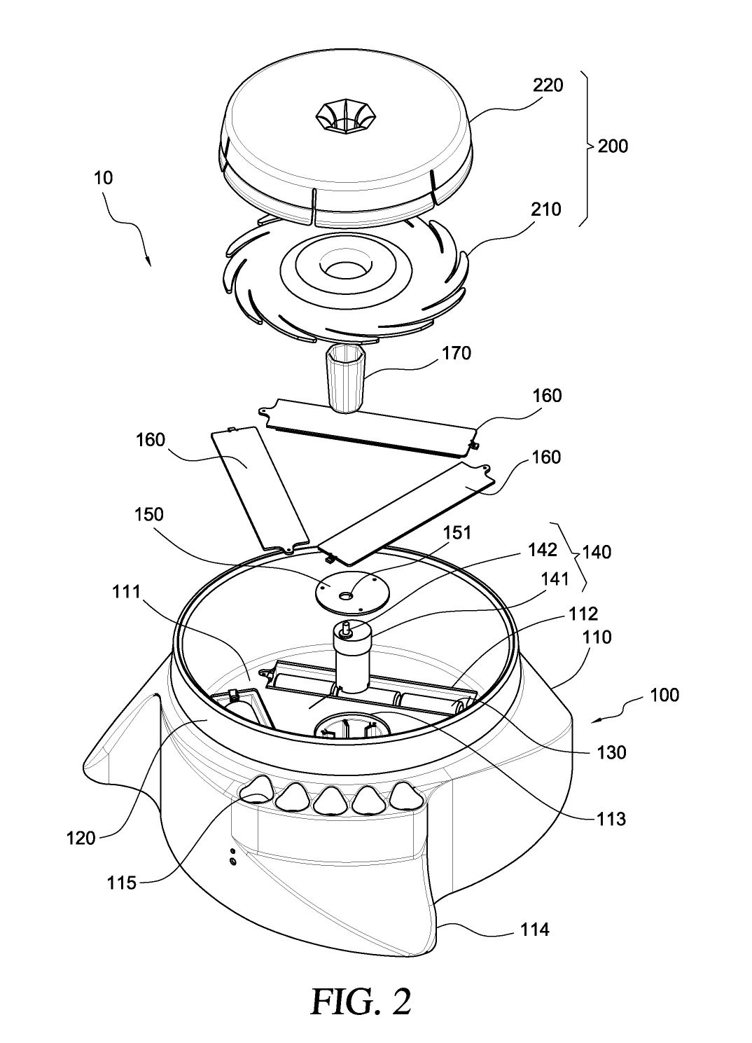

FIG. 2 shows an exploded view of the spinning device 10 including the housing 100 with the base portion 110 and the substantially vertical portion 120 integrally formed with the base portion 110.

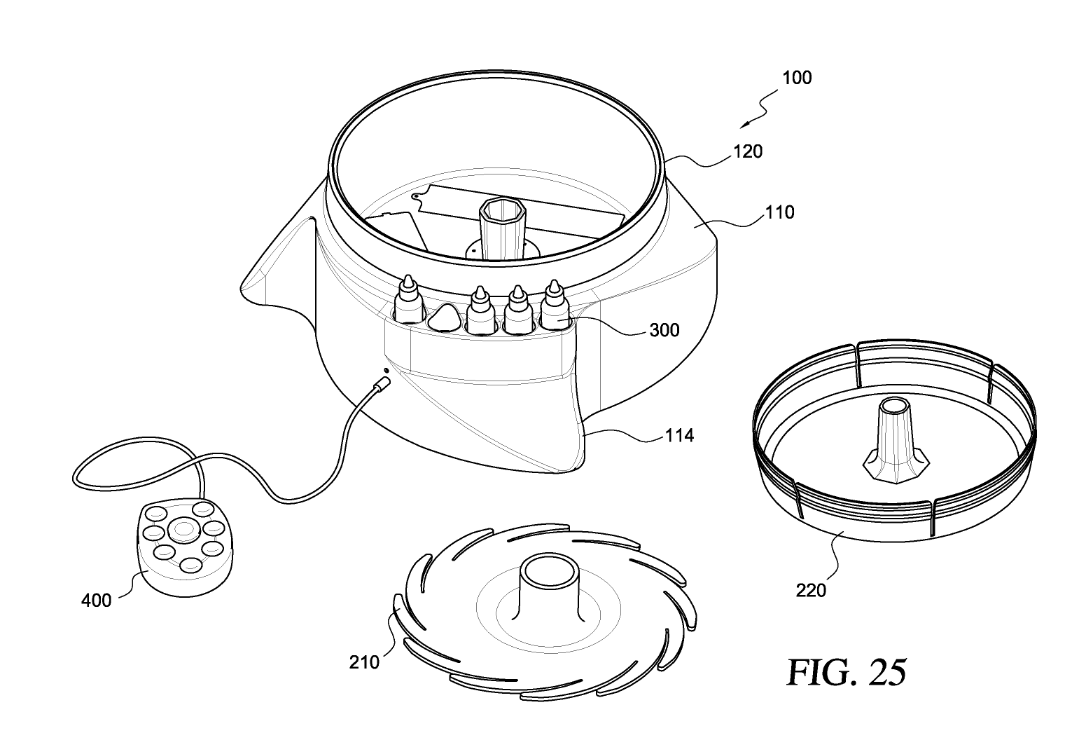

The base portion 110 has a generally cylindrical shape and includes multiple (3 shown) integrally formed fin-like protrusions 114 positioned equidistantly around an outside surface of the base portion 110. The fin-like protrusions 114 start at their widest (from a top view of the housing) at an upper end of the base portion 110 and gradually thin down toward the bottom of the base portion 110 to give the appearance of fin-like members protruding from the base portion 110. The fin-like protrusions 114 also protrude away from the base portion 110 at an angle relative to the base portion 110 so that when looked at it from the top of the housing 100 they give the appearance of turning blades. At the bottom of the base portion 110 the protrusions 114 form multiple bases on which the housing 100 rests during the spinning. The lower portions of the protrusions 114 therefore act as leg-members to provide stability to the housing 100 and to ensure that the housing 100 is not moving during the spinning operation. At least one of the protrusions 114 has on an upper wider portion thereof a plurality of pockets (for example, recesses) 115 in which paint bottles 300 (shown in FIG. 25) can be securely held. The protrusions 114 can be integrally formed with the base portion 110 and can be made of the same material (plastic, for example) as the rest of the housing 100.

The upper surface 111 of the base portion 110 extends from the upper portion of the base portion 110 so as to be substantially perpendicular thereto and so as to be substantially perpendicular to the vertical portion 120. The upper surface 111 of the base portion 110 includes a plurality of recesses 112, 113.

Recesses 112 (three (3) recesses, for example) are positioned equidistantly around the center of the upper surface 111 of the base portion 110 and are shaped so that each one can receive and securely hold a battery or a plurality of batteries 130 (3 D cell batteries, for example). Battery cover plates 160 are used to cover all recesses 112 inside which the batteries 130 are positioned. The cover plates 160 are shaped so that, when in place, they are flush with the upper surface 111 of the base portion 110.

Recess 113 is positioned in the center of the upper surface 111 of the base portion 110 and is shaped so that it can receive and securely hold a rotating mechanism 140 including a motor and a motor shaft 141. Recess 113 can also be covered with a motor plate 150. The motor plate 150 includes an aperture 151 so that when positioned over the recess 113, a securing member (receiver) 142 attached to the motor shaft 141 engages the driver 170, positioned inside the vertical portion 120, through aperture 151, while the motor plate 150 is flush with the upper surface 111 of the base portion 110. The rotating mechanism 140 positioned in recess 113 can be powered by a power source at about 100 V, which power source could be external to the spinning assembly (power outlet) or internal to the spinning assembly, such as the batteries 130 located in recesses 112. The motor can be activated by a user via a user-engageable switch knob 400 (shown in FIG. 25). The switch knob 400 can be a variable resistance switch that permits the user to selectively vary the speed at which the carrier assembly 200 is being rotated. The battery covers 160 as well as the motor plate 150 can be made of similar material (plastic, for example) as the housing 100 and can be fastened to the upper surface 111 of the base portion 110 using any available fastening means, such as, but not limited to screws, nails, bolts, spikes, pins, pegs, brackets, bearing plates, friction, and any other fastening means available for the particular application.

The vertical portion 120 extending upwardly from an upper surface 111 of the base portion 110 and defining an axially aligned open ended channel through which the coloring agent is applied onto the material positioned on the rotatable carrier assembly 200 houses the driver 170. The driver 170 securely engages with the receiver 142 through aperture 151 as well as with the rotatable carrier assembly 200 including a plunger 210 and a saucer 220. The driver 170 engages the receiver 142 and the carrier assembly 200 so that, when the rotating mechanism 140 is turned on, the motor spins the motor shaft 141 and the receiver 142, which in turn spins the driver 170, and ultimately the rotatable carrier assembly 200 at a predetermined speed of between 1-1000 rpm (rotations per minute). The receiver 142, the driver 170, and the carrier assembly 200 rotate together as a unit.

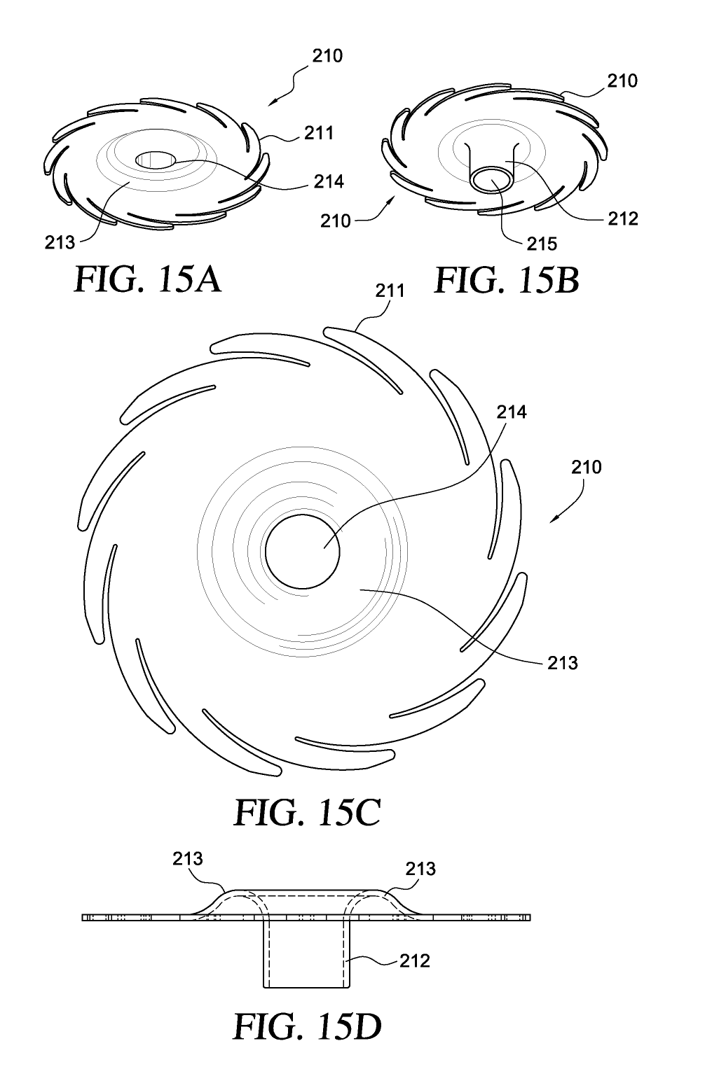

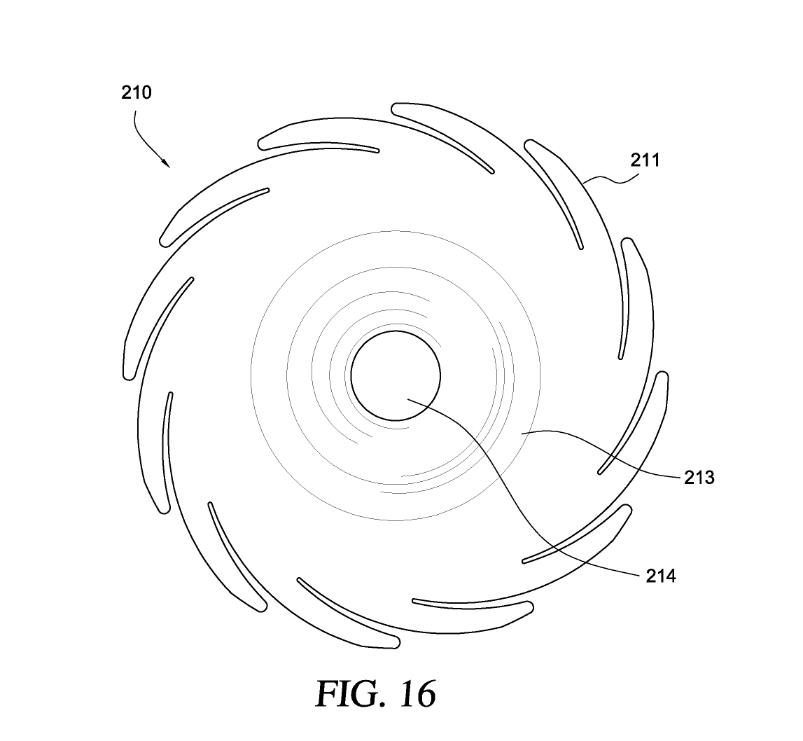

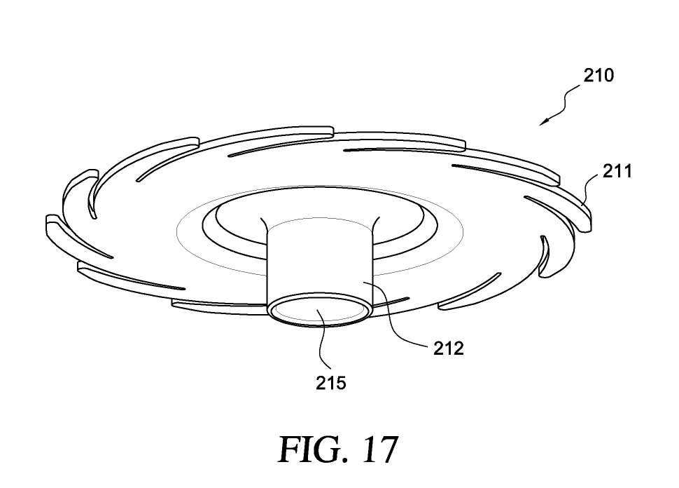

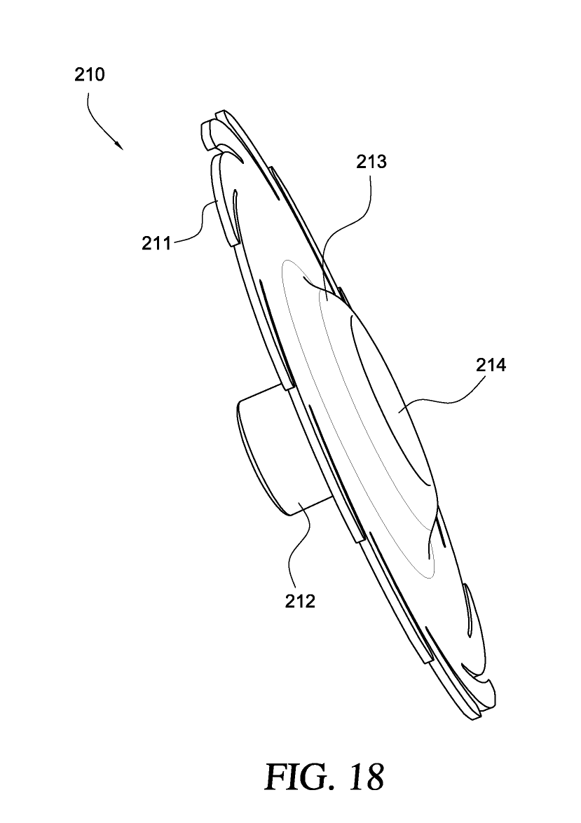

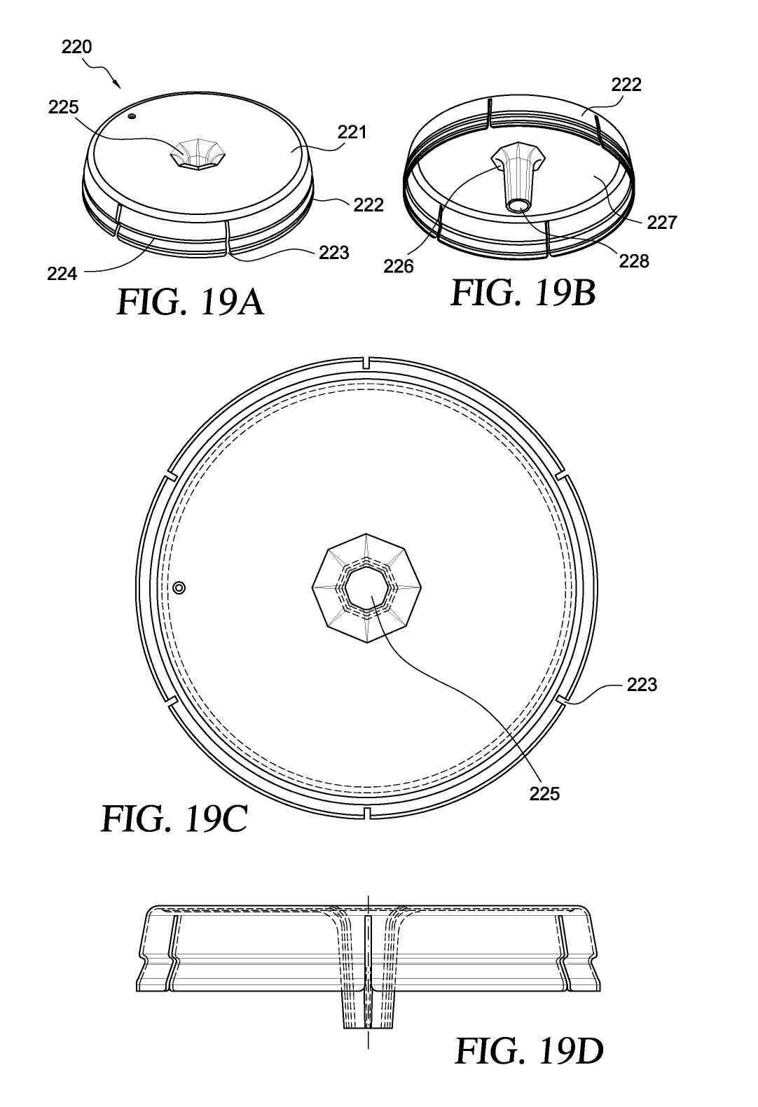

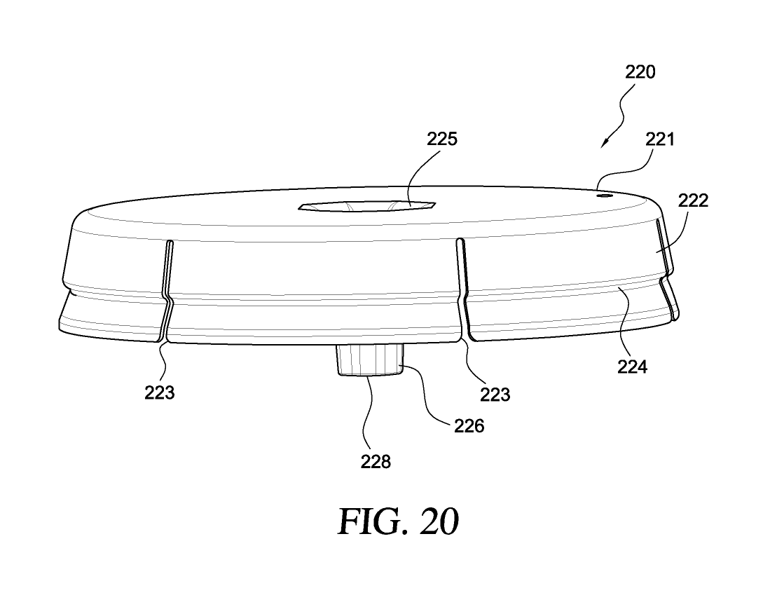

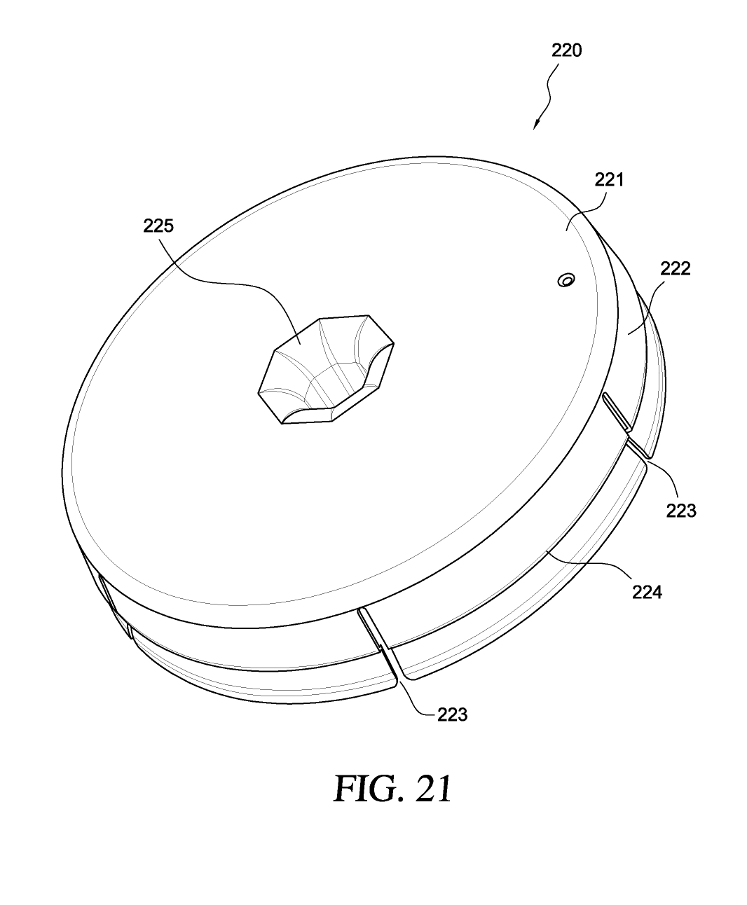

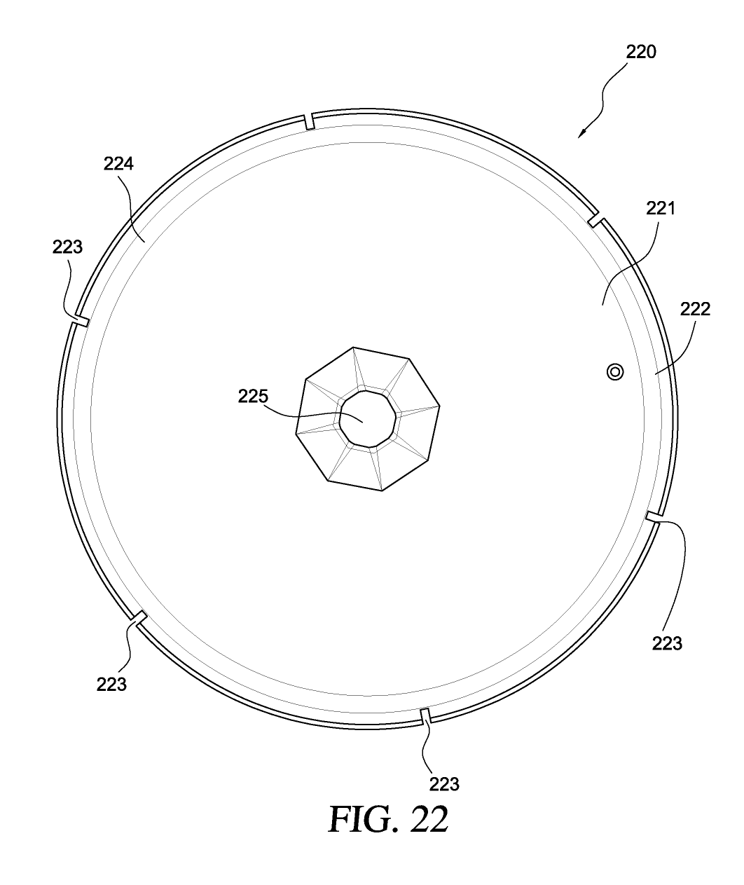

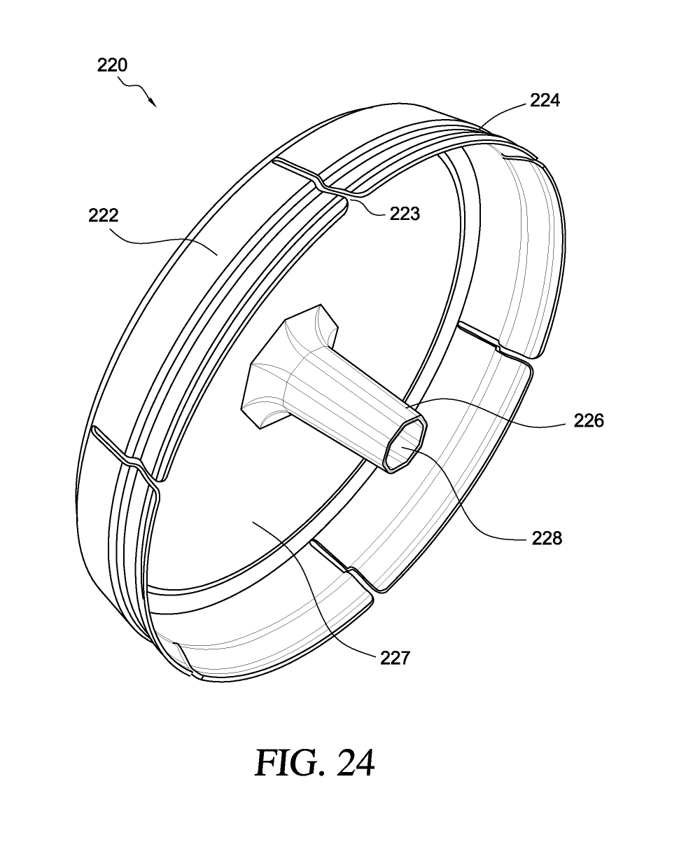

The rotatable carrier assembly 200 is used to securely hold the material in place during spinning. The carrier assembly 200 can include a substantially circular platelike platform, for example, but not limited to, a dimpled plunger 210 (shown in more detail in FIGS. 15A-18), and a disc-like platform 220, such as, but not limited to, a saucer or carrier (shown in more detail in FIGS. 19A-24), the dimpled plunger 210 and the saucer 220 being detachably attached to each other. The saucer 220 is also detachably attached to the driver 170, which snugly connects with the receiver 142 through the opening 151 located in the battery cover plate 150.

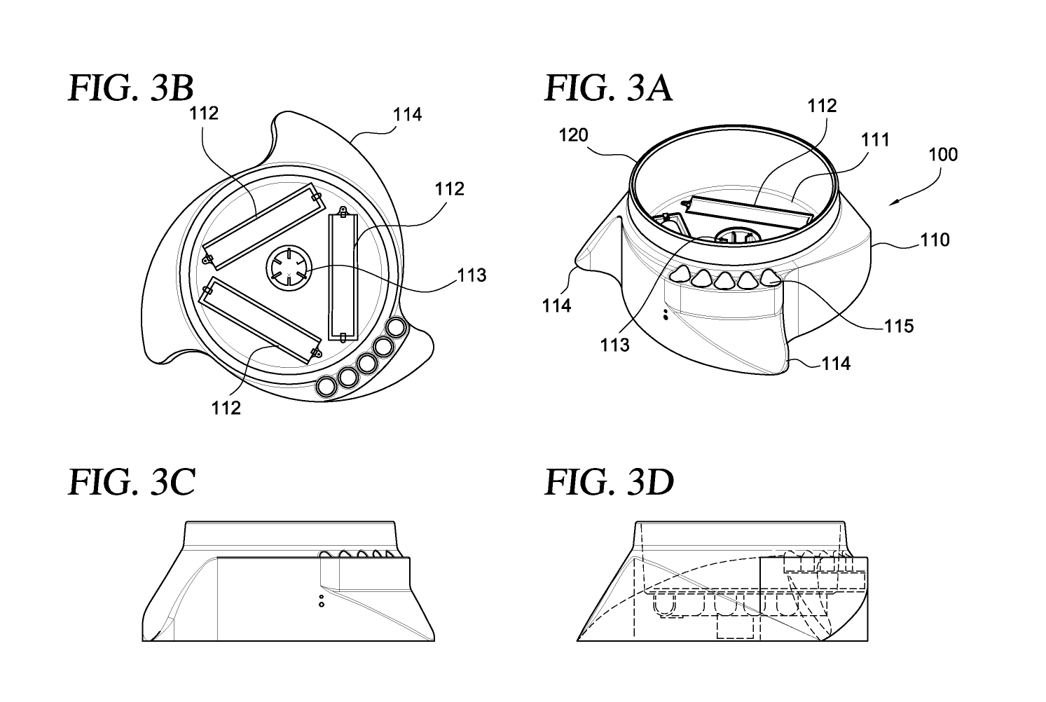

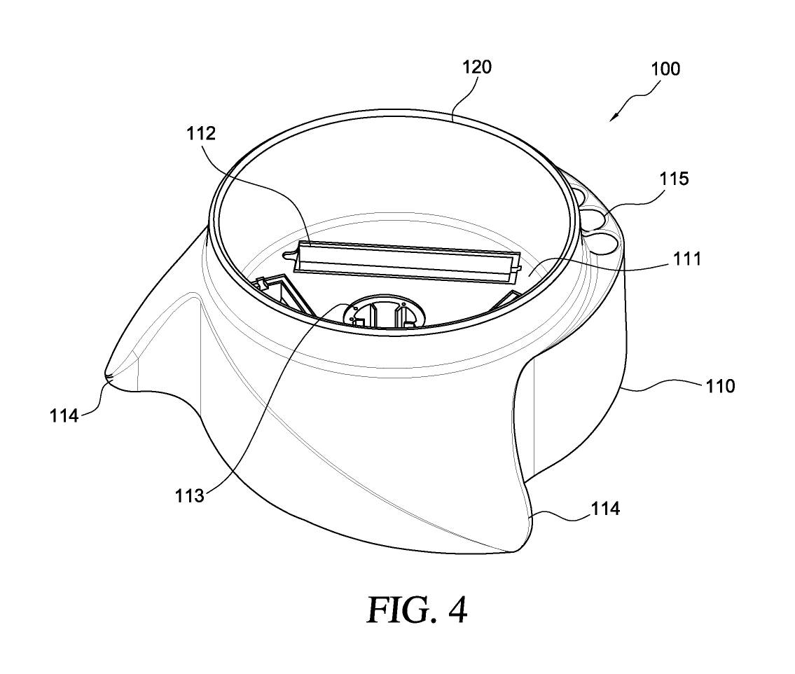

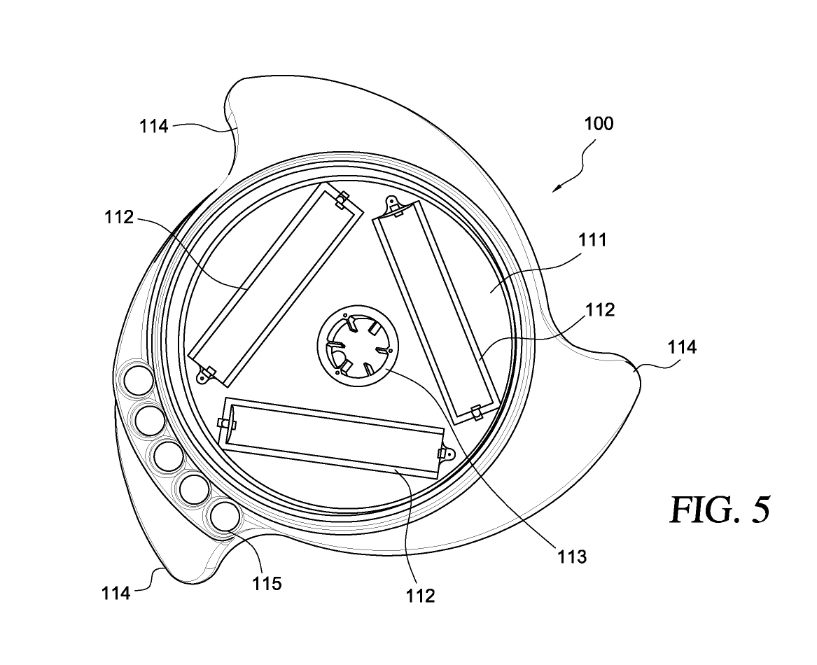

FIGS. 3-5 show different side, top and top perspective views of the housing 100 with the base portion 110 and the integral vertical member 120.

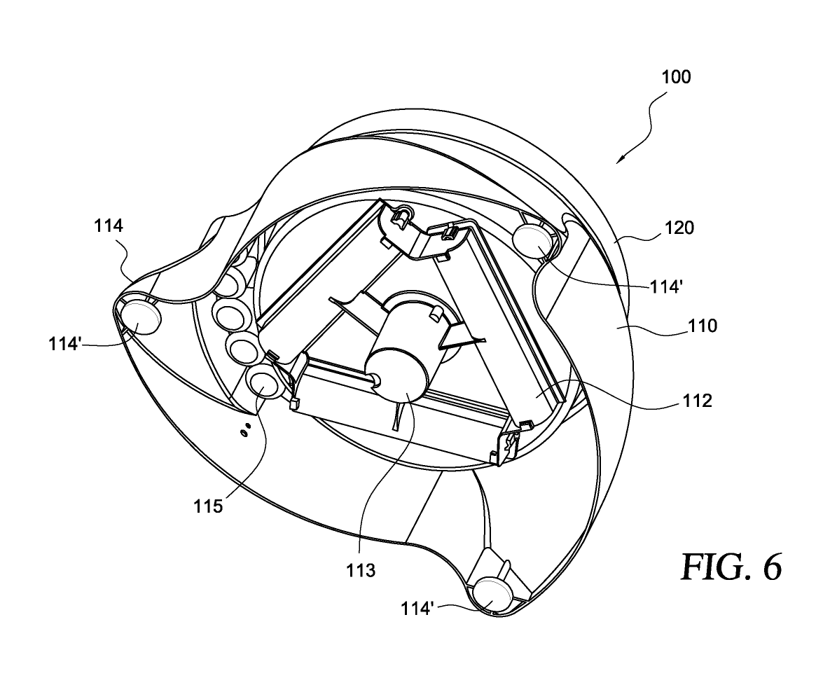

FIG. 6 shows a bottom perspective view of the housing 100. The power sources (batteries) 130 in recesses 113 are electrically connected (not shown) to the rotatable mechanism 140 (not shown) positioned in recess 113 so that the rotatable mechanism 140 is powered using the batteries 130.

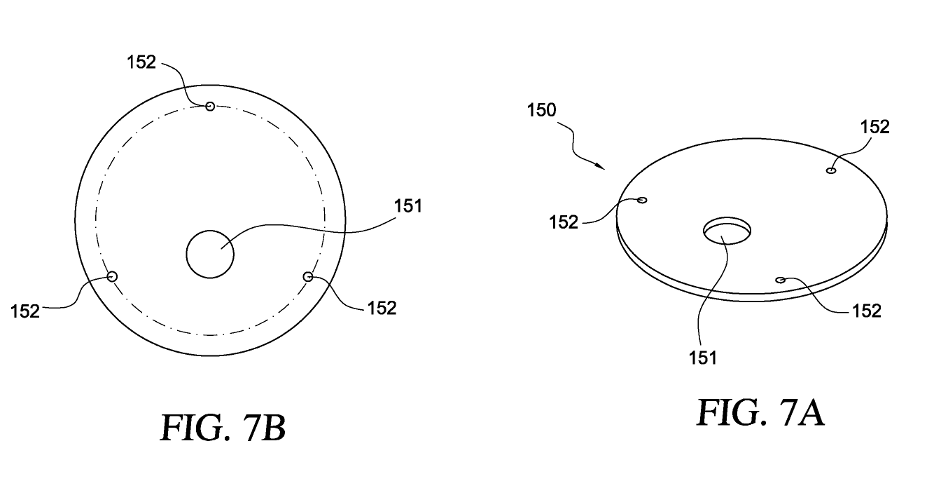

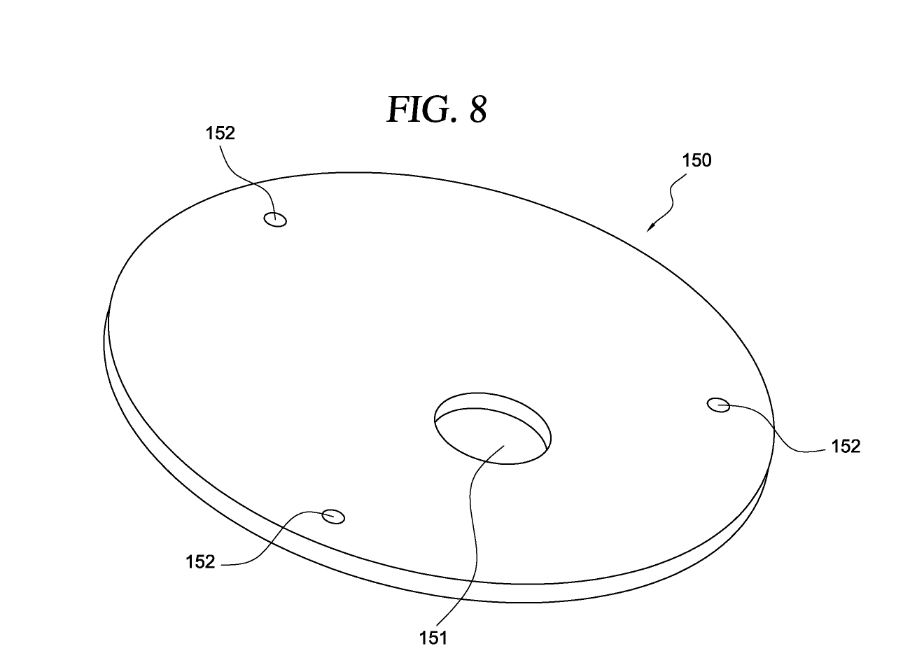

FIGS. 7A, 7B and 8 show an exemplary motor plate 150 to be used to cover the recess 113 in which the rotating mechanism 140 including the motor and the motor shaft 141 is snugly positioned. The motor plate 150 is a substantially circular plate with an aperture (opening) 151 offset from the center of the plate 150 to fit the receiver 142 therethrough. The receiver 142 is also offset from the center of the motor shaft 141. The motor plate 150 also has multiple (three, for example) attachment apertures 152 by which the motor plate 150 is securely fastened to the upper surface 111 of the base portion 110. When the motor plate 150 is fastened to the upper surface 111 of the base portion 110 it is flush with the upper surface 111 with the receiver 142 positioned vertically above the upper surface 111.

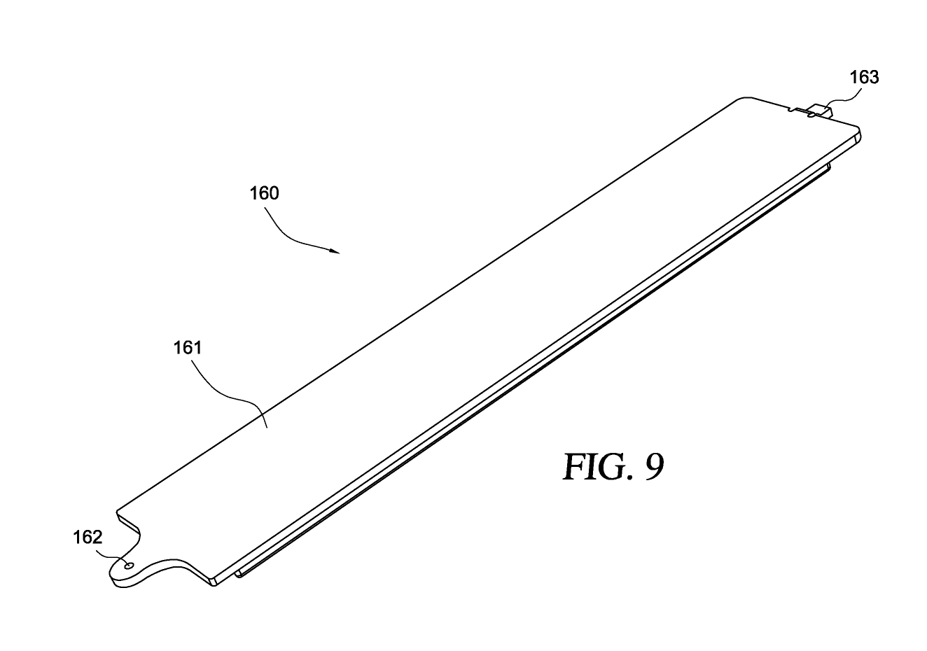

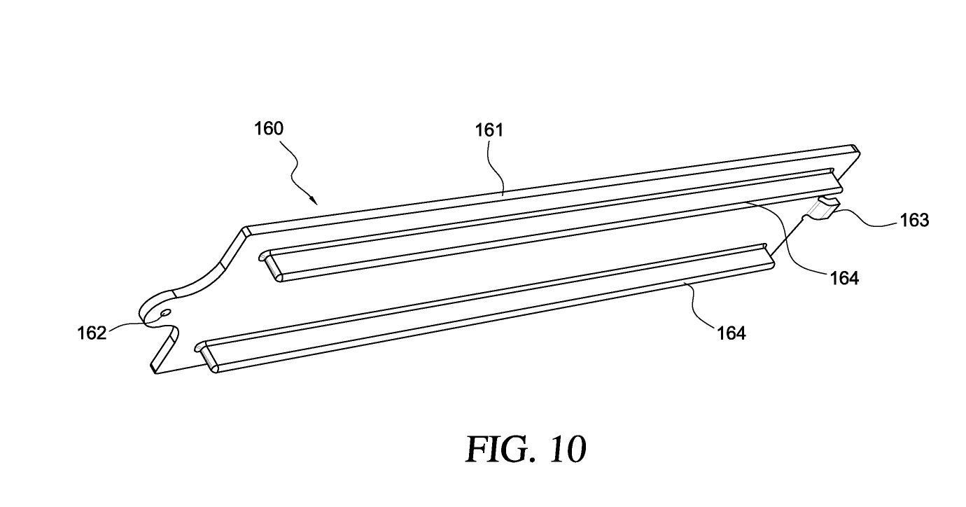

FIGS. 9-10 show an exemplary battery cover plate 160. The battery cover plate 160 includes a substantially rectangular member 161 long enough to cover the length of the recess 112 in which the power source (batteries, for example) are located. Leg members 164 positioned on and depending substantially perpendicularly away from a bottom surface of the battery cover plate 160 are added so that when the battery cover plate 160 is fastened to the upper surface 111 of the base portion 110, the leg members 164 snugly fit around the batteries in the recess and therefore reduce any movement of the batteries during the spinning process. The battery cover plate 160 is securely fastened to the upper surface 111 of the base portion 110 through fastener channels 162 through which fasteners, for example, but not limited to, threaded bolts, can be passed to secure the battery cover plate 160 to the upper surface 111 of the base portion 110. Additional attachment means 163 can also be used to fasten the battery plate 160 to the surface. All attaching, fastening and securing means and devices disclosed can include, but are not limited to, screws, nails, bolts, spikes, pins, pegs, brackets, bearing plates, friction, and any other fastening means available for the particular application.

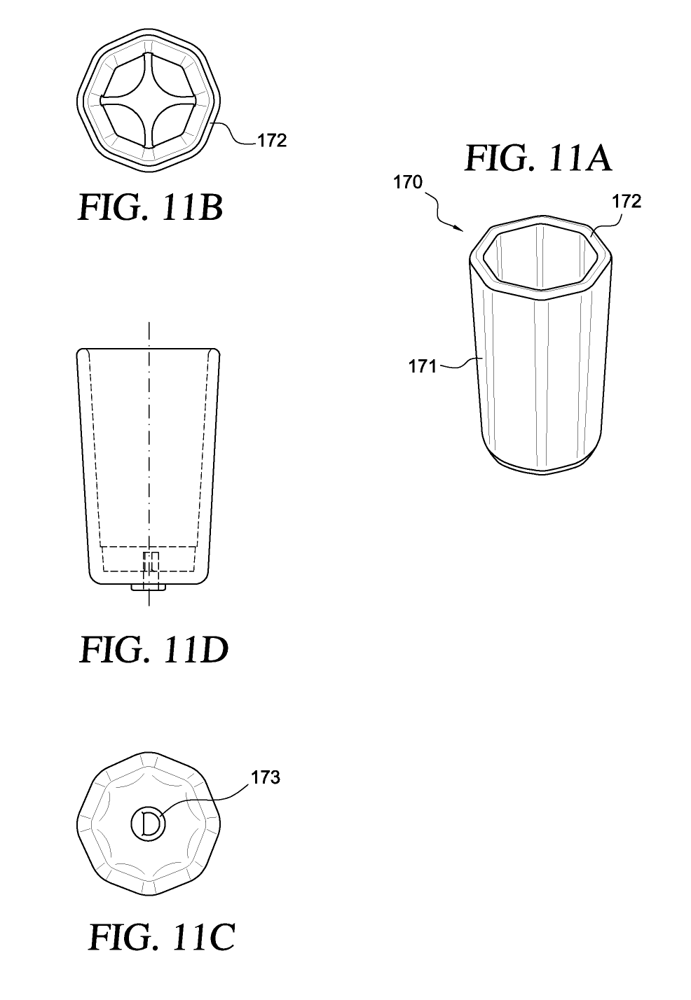

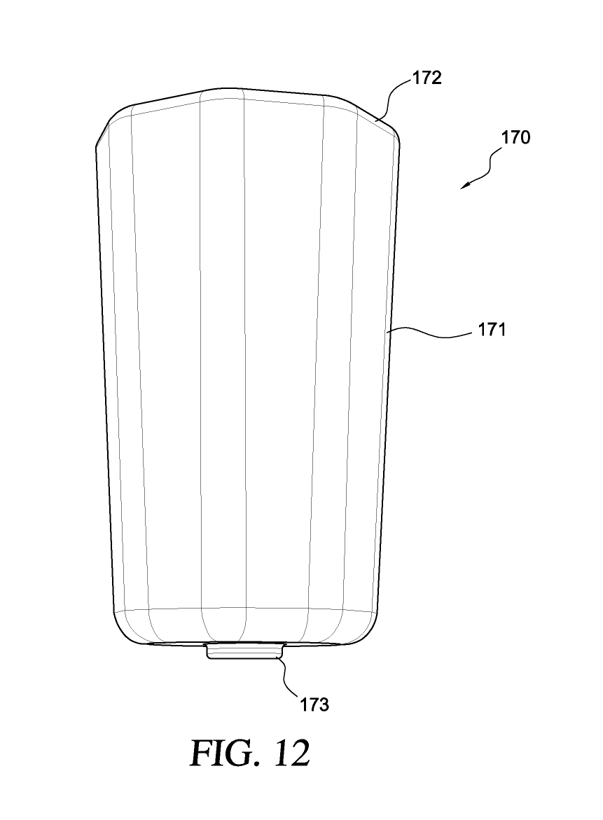

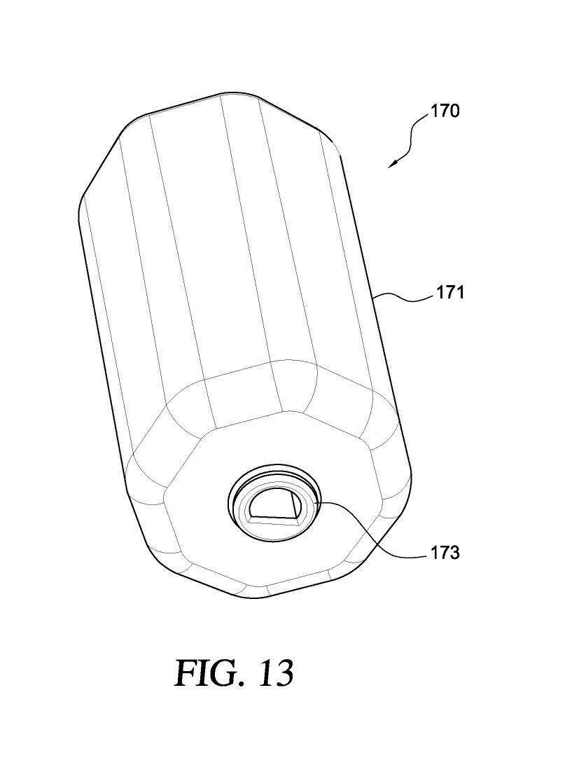

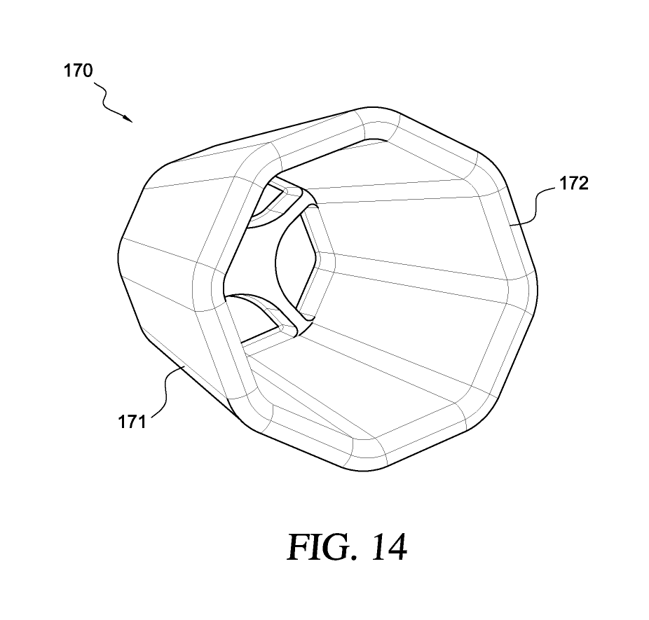

FIGS. 11A-14 illustrate an exemplary driver 170 used to securely attach the receiver 142 on the motor shaft 141 to the carrier assembly 200, and to facilitate rotation of the carrier assembly 200 around a spinning axis when the rotating mechanism 140 is turned on and the spinning commences. The driver 170 has a generally conical shape with a plurality of ridges (corrugations) 171 along its length and with its two connecting ends 172 and 173 shaped so as to snugly engage the carrier assembly 200 and the receiver 142, respectively. As seen in FIGS. 11A-14, the driver 170 has a substantially octagonal cross-section.

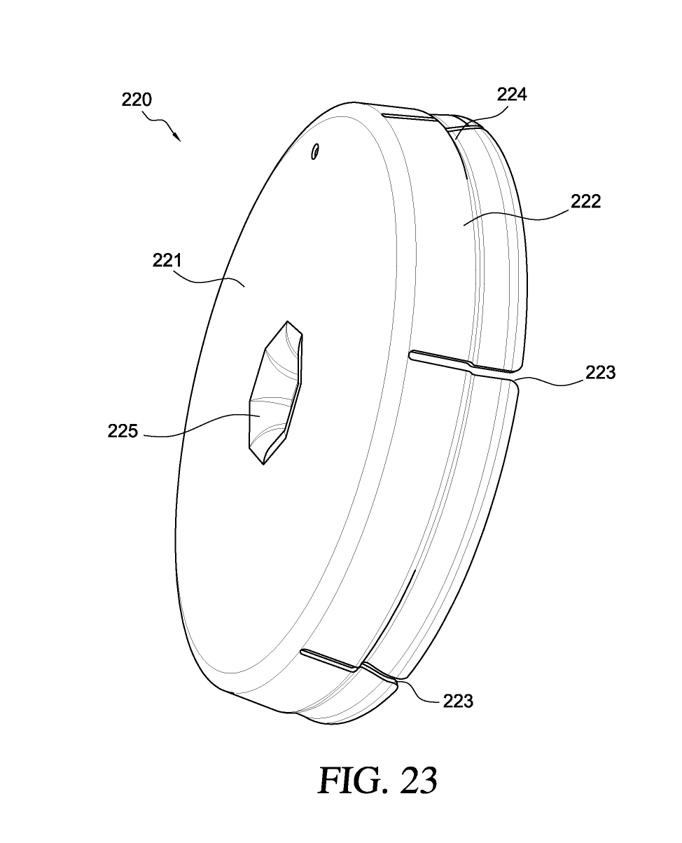

The plunger 210 shown in FIGS. 15A-18 has a generally circular shape and can include finger-like spiral members 211 around an outer edge that act like springs to clamp the material in place. The finger-like spiral members 211 also apply pressure to the inside of the saucer 220 to provide friction between the saucer 220 and the plunger 210 so that together the saucer 220 and the plunger 210 provide the secure material holding assembly 200 and so that the saucer 220 and the plunger 210 rotate together as a unit during spinning. The plunger 210 is further configured to keep the saucer 220 from detaching (climbing off, moving away) from the plunger 210 during spinning. Various friction enhancing elements can also be used, including adding detents to the surface of the saucer, to increase friction between the saucer 220 and the plunger 210. The plunger 210 further includes an opening 214 on its top surface and a funnel-like elongated connecting member 212 formed integrally with the top surface of the plunger 210 so that a conduit 215 is established through the plunger 210. A continuous dimple (indent) 213 positioned around the plunger opening 214 can also be added so that the upper surface of the plunger 210 fits snugly against the saucer cavity 227 (shown in FIGS. 19B and 23). The dimpled plunger 210 can be made of a plastic material.

The saucer 220 shown in FIGS. 19A-24 can include a substantially disc-like surface 221 and a substantially circular side skirt 222 positioned around the periphery of the disc-like surface 221 to form a cavity 227 underneath the surface.

The side skirt 222 can be formed integral with the disc-like surface 221 and can further include an indent 224 along its circumference at approximately half-length point to additionally secure the snug fit of the dimpled plunger 210 against the saucer cavity 227. The indent 224 also serves as a visual alert as to when the plunger 210 and the saucer 220 are correctly fitted. The fitting is complete when the finger-like spiral members 221 of the plunger 210 have been pressed below (when looking at it from the bottom side of the saucer) the side skirt indent 224. The side skirt 222 can also include a plurality of grooves 223 positioned at predetermined distances along the length of the side skirt 222 so as to separate the side skirt 222 into a plurality of flexible side skirt sections and thereby increase the skirt's overall flexibility. The saucer 220 can also include a funnel-like elongated connecting member 226 in the saucer cavity 227 to establish a conduit 228 through the saucer starting at an opening 225 in the center of the disc-like surface 221. The connecting member 226 can be formed integrally with the disc-like surface 221 and is shaped to fit through the opening 214 on the upper surface of the plunger 210 with a portion of it sticking out from the plunger conduit 215. The sticking out portion of the saucer connecting member 226 engages the driver 170 through the plunger conduit 215 and snugly fits into the driver end 172. The saucer connecting member 226 and the driver end 172 have corresponding ridges to assure a snug fit and so that, after engagement with each, other the driver 170 and the carrier assembly 200 spin together as a unit.

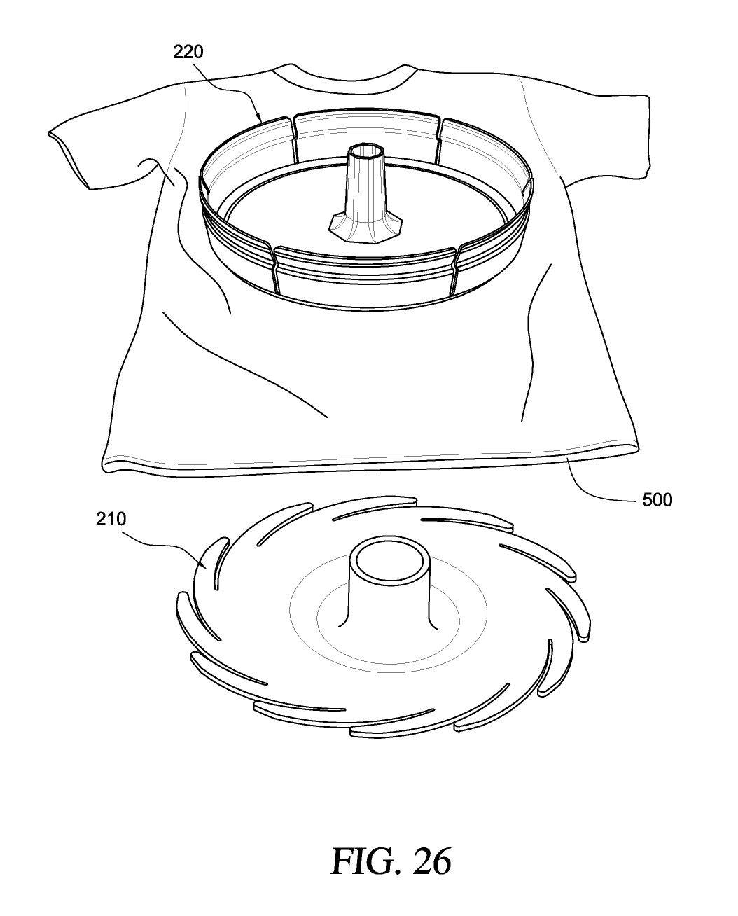

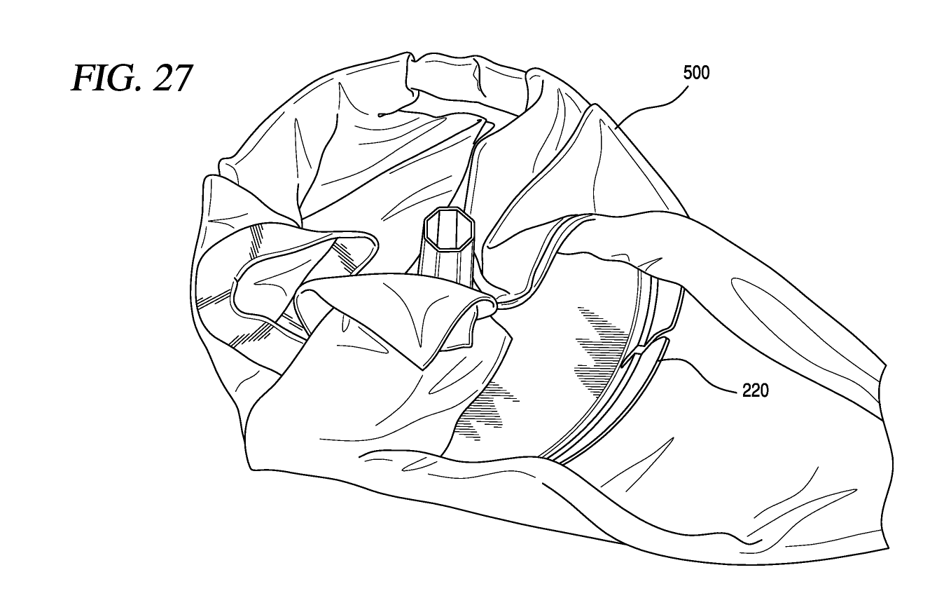

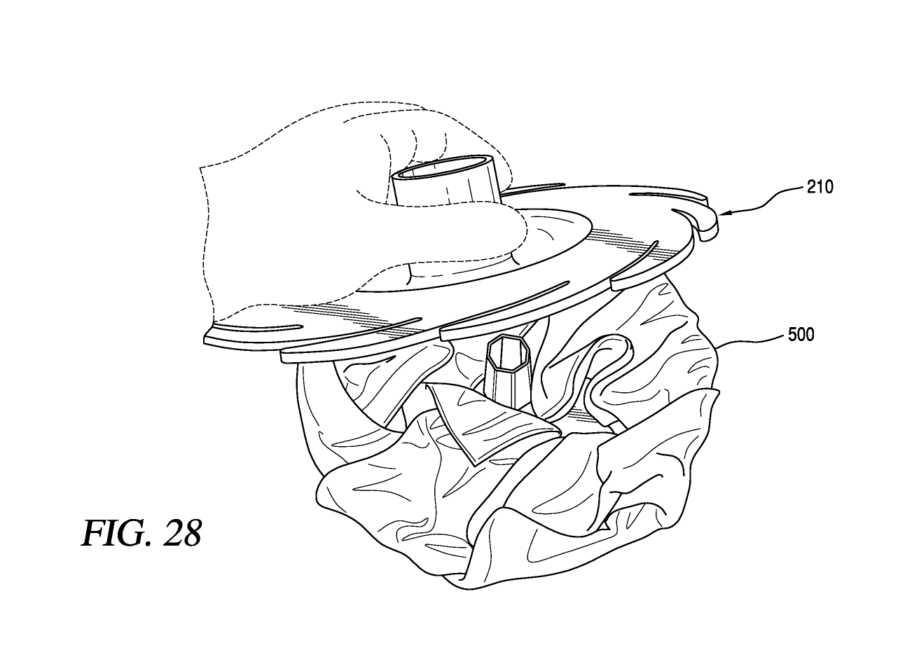

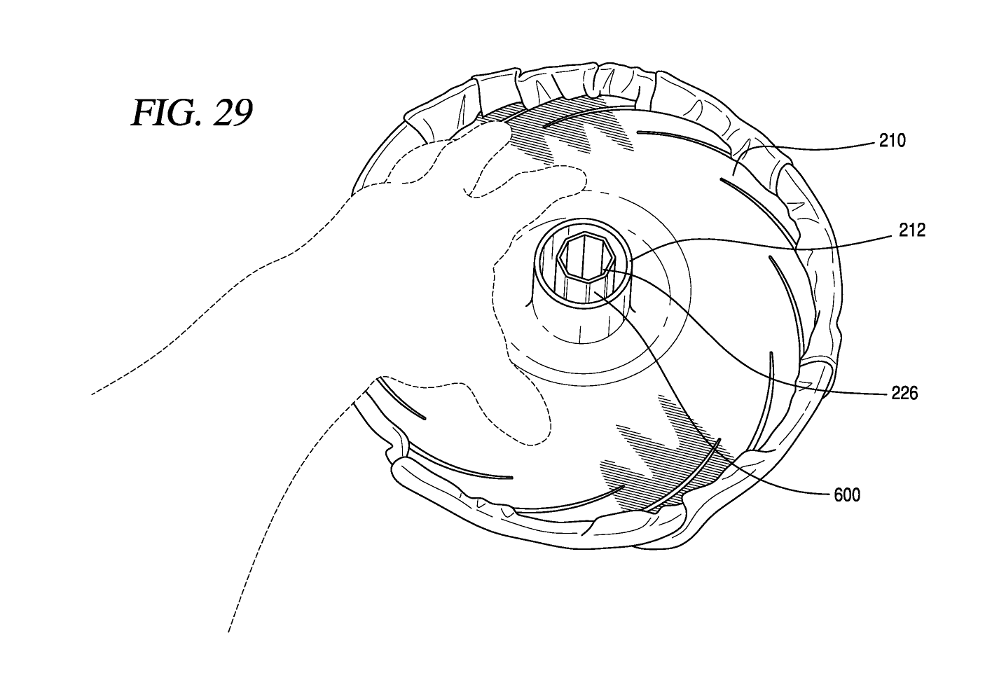

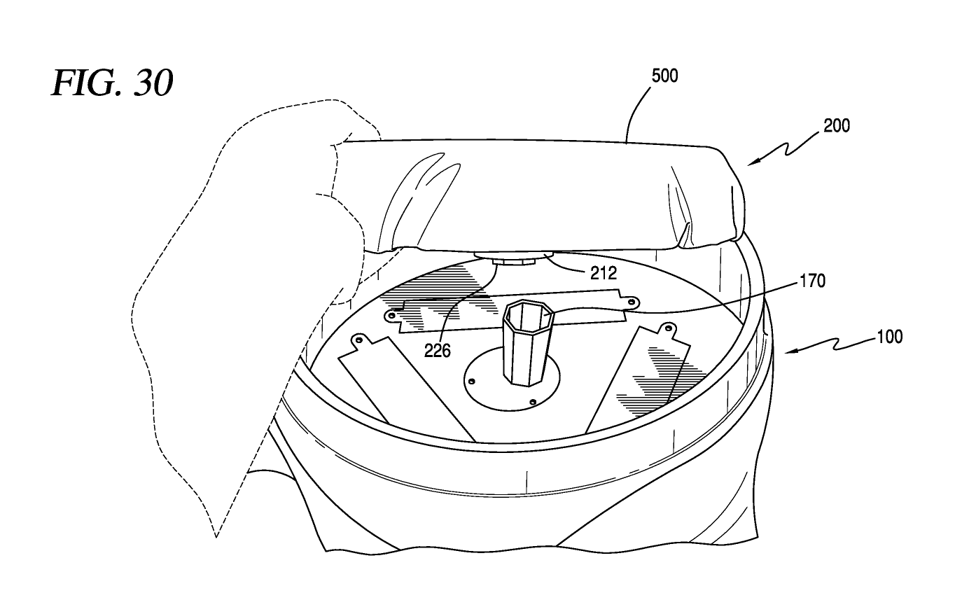

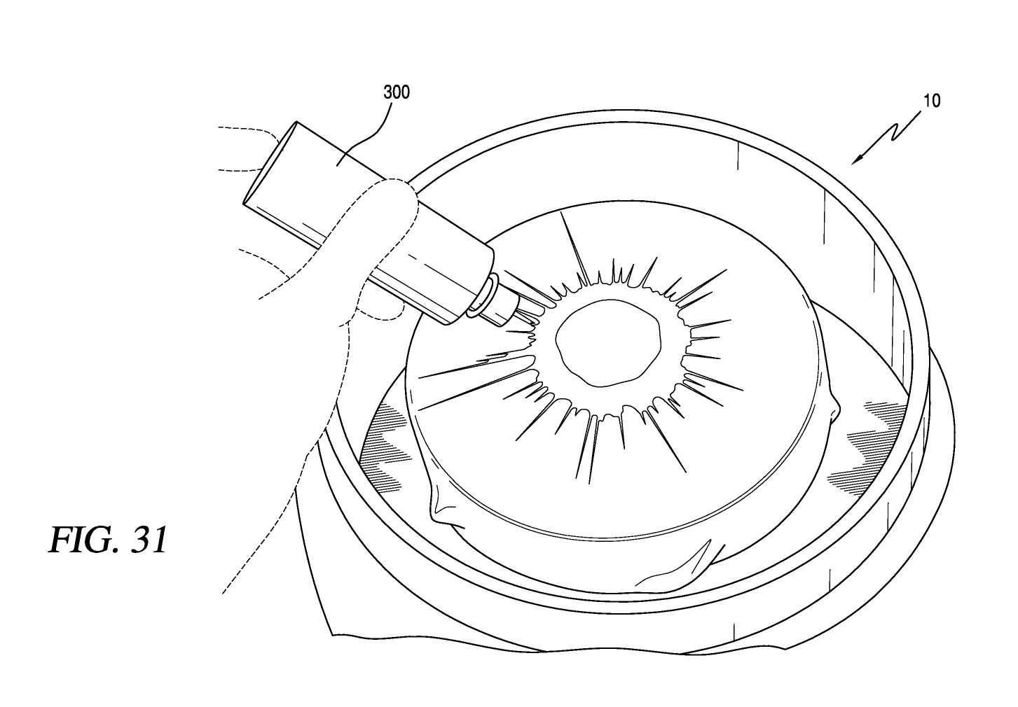

FIGS. 25-31 show the spinning device 10 in operation. Before the spinning starts, a portion of the material 500 that will be painted is laid on a top surface of the saucer 220, and the rest of the material 500 is securely tucked underneath the saucer 220 so that the saucer connecting member 226 is not covered by the material 500.

The saucer 220 is next fastened to the plunger 210 by inserting the saucer connecting member 226 into the plunger conduit 215. When the plunger 210 is pushed against the saucer cavity 227, a portion of the saucer connecting member 226 sticks out from the plunger connecting member 212. The diameter of the saucer connecting member 226 is less than the diameter of the plunger connecting member 212 and so there is also some space 600 left between the connecting members 226 and 212. The saucer 220 and the plunger 210 engage with each other so that, in use, the saucer 220 and the plunger 210 spin together as the rotatable carrier assembly 200. The plunger's finger-like spiral members 212 act like springs to clamp the material 500 in place. The finger-like spiral members 212 also apply pressure to the inside of the saucer 220 to provide friction between the saucer 220 and the plunger 210 so that the saucer and the plunger together provide a secure holding mechanism for the material and so that the saucer and the plunger rotate together as one unit 200 during spinning around a spinning axis along a vertical line through the center of the driver 170.

Once the material 500 is securely fastened, the carrier assembly 200 is connected to the driver 170. The driver end 172 slides into the space 600 left between the members 212 and 226 until there is a snug non-rotatable connection between the driver 170 and the saucer connecting member 226. The fit has to be snug enough so that the driver 170 and the carrier assembly 200 rotate together during spinning without the saucer 220 and/or the plunger 210 detaching (climbing off, moving away) from the driver 170 or from each other.

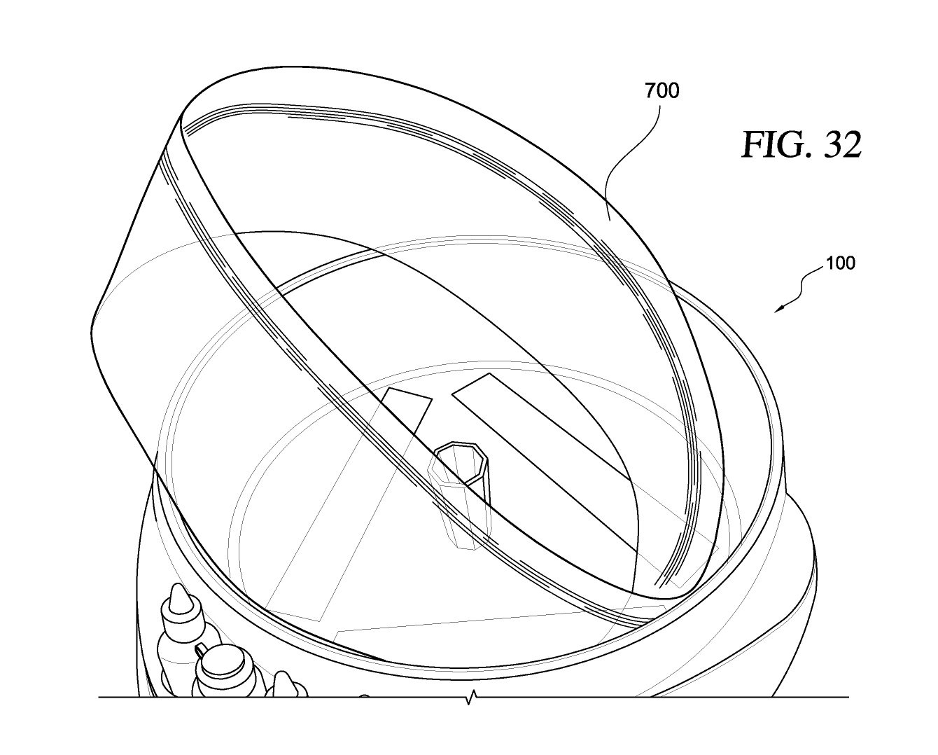

Once the device 10 is turned on by pushing the user-engageable switch knob 400, and the material 500 is spinning, the user can apply different paints, etc. onto the spinning material until a desired design pattern is generated. During spinning, the vertical portion 120 of the housing 100 protects the user from the splashing paint. Additionally, as shown in FIG. 32, a disposable liner 700 having a cylindrical shape positioned inside the vertical portion 120 of the housing 100 may be used to protect the inside of the housing 100 from splashing paint. After the spinning is done, the disposable liner 700 can be removed from the housing 100 and the paint can be washed off of it before the liner 700 is used again. In the alternative, a new liner can be inserted into the housing. A lid (not shown) can also be pivotally secured to the housing 100 to protect the user from being splashed with paint during the spinning. Sheer, translucent, opaque, metallic, interference as well as pearlescent paints, acrylic paints, heat setting paints, as well as paints formulated specifically for textiles, can be used to create the spin-art. Also, any type of material, such as, cotton, muslin, silk, velvet, rayon, polyester, or any other type of fabric can be used in the spinning device to create the wearable art.

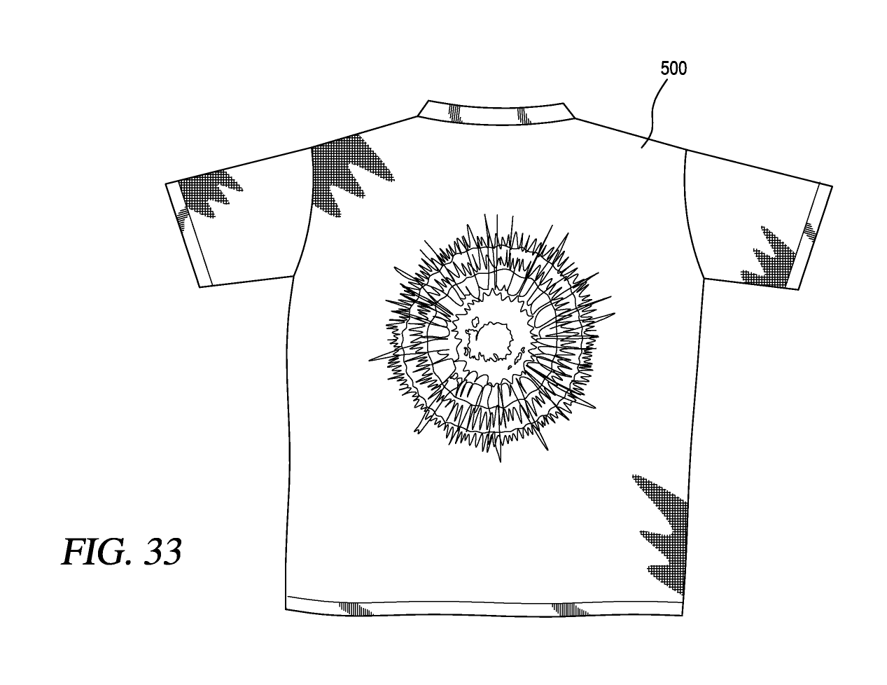

After the desired pattern is generated, the wet material can be dried using different drying methods. The material can be allowed to dry naturally on a drying cord (see FIG. 33), or the drying process can be accelerated by applying heat to the material using a drying oven and/or a spin or flash dryer.

The spinning device 10 can further include a lifting device (not shown) attached to the upper surface 111 of the base portion 110 used to disengage the carrier assembly 200 from the driver 170 after the spinning of the carrier assembly 200 is done. The lifting device can include one or more movable members positioned inside the vertical member 120 of the housing 100 and detachably attached (connected) to the upper surface 111 of the base portion 110 so as to be substantially perpendicular to the upper surface 111 of the base portion 110 and so as to extend along a direction which is parallel with an axis of rotation of the driver 170. The one or more movable members can extend to a height just below the plunger 210 so that during the spinning of the carrier assembly 200 the plunger 210 or any other part of the carrier assembly 200 does not touch the one or more movable members. The one or more movable members are further configured to move up and down along a direction parallel to the axis of rotation of the driver 170 so that after the carrier assembly 200 is done spinning, the one or more movable members can be moved in an upward direction to touch a bottom surface of the plunger 210 at one or more locations and to ultimately move the carrier assembly 200 in an upward direction away from the driver 170 and detach the carrier assembly 200 from the driver 170. The upper portions of the one or more movable members are shaped so as to safely hold the carrier assembly 200 after the carrier assembly 200 is detached from the driver 170. In a variation, the upper portions of the one or more movable members can be shaped so as to snugly fit into one or more apertures (not shown) located on the bottom surface of the plunger 210 to safely hold the carrier assembly 200 after the carrier assembly 200 is detached and moved away from the driver 170. The one or more movable members can be telescopic rods or can be rod-like devices connected to a moving mechanism which when activated allows for the rod-like devices to move up and/or down. The moving mechanism can include a switch button (not shown) which when turned to an ON position activates the moving mechanism and/or a pedal-like mechanism which when pushed moves the one or more rod-like mechanism toward the bottom of the plunger 210.

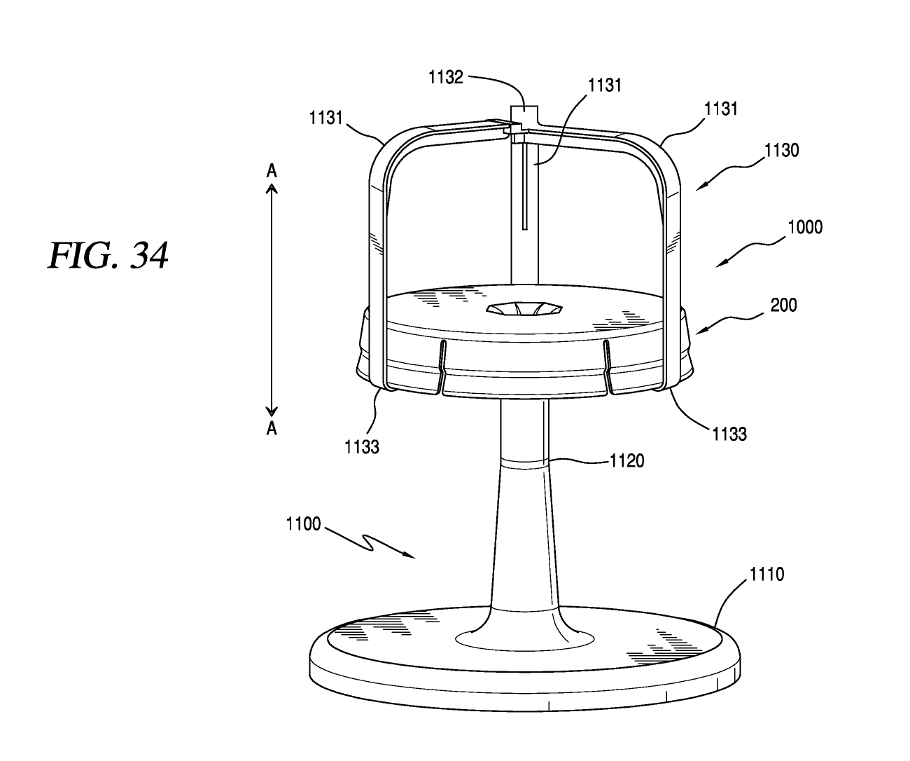

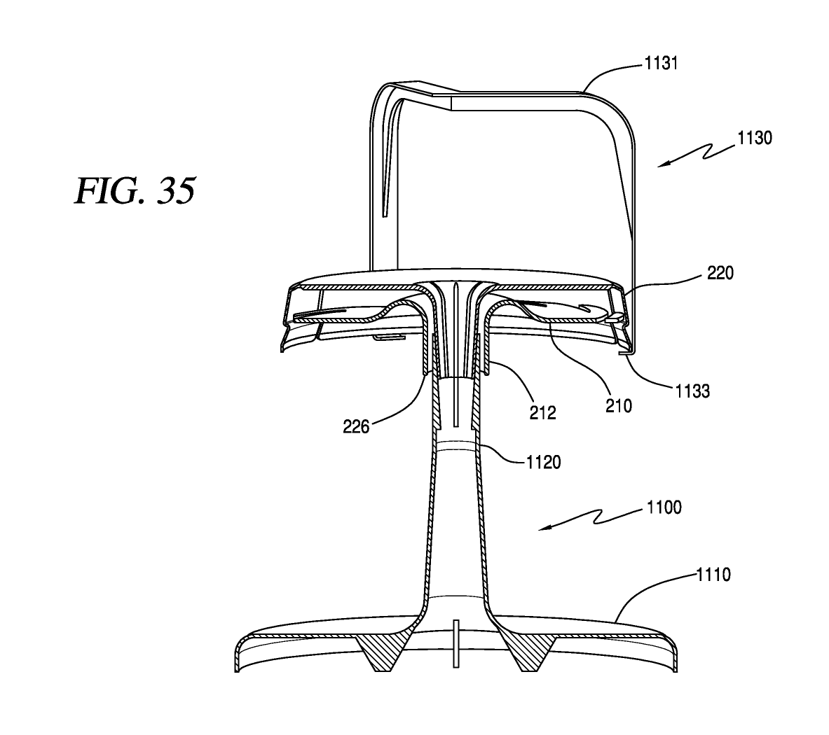

FIGS. 34 and 35 show different views of a disassembling device 1000 used to hold and disassemble the carrier assembly 200 after it has been removed from the spinning device 10 using a lifting device 1130 to free the painted material. The disassembling device 1000 facilitates the separating of the saucer 220 from the plunger 210 without smudging the wet paint on the material. The disassembling device 1000 can include a holding device 1100 to hold the carrier assembly 200 before the plunger 210 is disengaged from and separated from the saucer 220. Using the disassembling device 1000, the painted material can be safely removed from the carrier assembly 200 and dried.

The lifting device 1130 is used to remove the carrier assembly 200 from the spinning device 10 without touching the wet paint on the material and without the material touching the disposable liner 700 inside the housing. The lifting device 1130 is configured to lift the carrier assembly 200 from the driver 170, to remove the carrier assembly 200 from the spinning device 10, and to position the carrier assembly 200 onto the holding device 1100.

The lifting device 1130 can include a plurality of arm members (hooks) 1131 detachably attached to each other at one end 1132 and with slightly inward bent free ends 1133 at the other end which together form a claw shaped lifting mechanism. One of the arm members 1131 can be movable in a vertical plane relative to the other arm members 1131 so as to make it easier to position the lifting device 1130 around the edge of the saucer 220. The free ends 1133 are bent just enough to securely hold the bottom edge of the saucer 220 during the lifting.

The holding device 1100 holds the carrier assembly 200 after it has been removed from the spinning device 10. The holding device 1100 includes a substantially circular base member 1110 and a substantially vertical member 1120 having a cylindrical shape attached to the base member 1110 and configured to securely hold the carrier assembly 200 at a top portion thereof. The top portion of the vertical member 1120 is shaped so as to snugly fit in the space 600 between the saucer connecting member 226 and the plunger connecting member 212 after the saucer connecting member 226 slides into the vertical member 1120. At least the top portion of the vertical member 1120 is shaped so that it allows the plunger 210 to slide in a downward direction when it is pulled downward by the plunger connecting member 212 while the saucer 220 remains in place. The saucer 220 separates from the plunger 210 after the plunger 210 is pulled downward away from the saucer 220. The plunger 210 is pulled until the painted material is freely hanging from the saucer 220.

In operation, after the carrier assembly 200 has stopped spinning, the arm members (hooks) 1131 of the lifting device 1130 are positioned around the bottom edge of the saucer 220 by first positioning the arm members (two integral arm members) 1131 which are connected to each other around the bottom of the saucer 220 and then snapping the movable arm 1131 around the bottom of the saucer 220 to securely fastened the lifting device 1130 around the bottom rim of the saucer 220. The lifting device 1130 is then moved up away from the spinning device 10 to disengage the carrier assembly 200 from the driver 170. Once separated from the driver 170, the carrier assembly 200 can be positioned on the vertical member 1120 of the holding device 1100 by sliding the protruding portion of the saucer connecting member 226 into the vertical member 1120 until the vertical member 1120 snugly fits in the space 600 between the saucer connecting member 226 and the plunger connecting member 212. The lifting device 1130 is then removed from the carrier assembly 200 by first unhooking the movable arm member 1131 and then unhooking the rest of the arm members from the carrier assembly 200. Once the lifting device 1130 is disengaged and removed from the carrier assembly 200, the plunger connecting member 212 is moved in a downward vertical direction on the vertical member 1120 and away from the saucer 210 until the sides of the painted material are freely hanging from the saucer 210. Once it is freely hanging, the painted material can be held up at two ends and moved to a drier to be dried.

In another alternative, after the carrier assembly 200 has stopped spinning, the carrier assembly 200 can be removed from the spinning device 10 by hand and the saucer 220 and plunger 210 can be separated from each other by prying up the bottom rim of the saucer 220 with a wrist. This separation method can be made easier using a saucer 220 with the plurality of side skirt sections because of the increased flexibility of the side skirt.

In yet another embodiment, after the carrier assembly 200 has stopped spinning, the carrier assembly 200 can be detached from the driver 170 using a lifting device (not shown) which can include one or more movable members (not shown) positioned inside the vertical member of the housing 120 and are detachably attached (connected) to the upper surface 111 of the base portion 110 so as to be substantially perpendicular to the upper surface 111 of the base portion 120 and so as to extend along a direction which is parallel with an axis of rotation of the driver 170. The one or more movable members can extend to a height just below the plunger 210 so that during the spinning of the carrier assembly 200 the plunger 210 or any other part of the carrier assembly 200 does not touch the one or more movable members. The one or more movable members are further configured to move up and down along a direction parallel to the axis of rotation of the driver 170 so that after the carrier assembly 200 is done spinning, the one or more movable members can be moved in an upward direction to touch a bottom surface of the plunger 210 at one or more locations and to ultimately move the carrier assembly 200 in an upward direction away from the driver 170 and detach the carrier assembly 200 from the driver 170. The upper portions of the one or more movable members are shaped so as to safely hold the carrier assembly 200 lifted after the carrier assembly 200 is detached from the driver 170. In an embodiment, the upper portions of the one or more movable members can be shaped so as to snugly fit into one or more apertures (not shown) located on the bottom surface of the plunger 210 and to safely hold the carrier assembly 200 after the carrier assembly 200 is detached and moved away from the driver 170.

The one or more movable members can be telescopic devices so that, when activated, inside portions of the telescopic devices are moved up or down to touch and/or move away from the plunger 210. In the alternative, the one or more movable members can be rod-like members (bars, for example) connected to a moving mechanism which when activated allows for the one or more movable members to move up toward or down and away from the plunger 210. The moving mechanism can include a switch button which when turned to an ON position activates the moving mechanism and/or a pedal-like mechanism that when pushed moves the one or more rod-like members up toward the bottom of the plunger 210. Once the carrier assembly 200 is pushed up and away from the driver 170, the carrier assembly 200 can be removed from the spinning device 10 by hand and the saucer 220 can be separated from the plunger 210 by prying the saucer 220 up and away from the plunger 210 by hand (using a wrist, for example).

Different materials, sizes, and dimensions for the housing, lid assembly, plunger, saucer, driver, the lifting and the disassembling devices can be used depending on the particular application. Additionally, different lighting and music playing mechanisms and devices can be included inside and/or on an outside surface of the housing.

In accordance with one or more embodiments of the present invention, the paint application apparatus as substantially shown and described herein.

In accordance with one or more embodiments of the present invention, the paint application system as substantially shown and described herein.

A device for creating a design on a material under the action of a centrifugal force, the device including a housing including a base portion and a substantially vertical portion formed integral with and extending substantially vertically upwardly from a top of the base portion, the base portion including one or more recesses in an upper surface thereof, at least one of the recesses being configured to receive a rotating mechanism configured to engage and rotate the rotatable member around a spinning axis, the substantially vertical portion having an opening therethrough. The device also including a rotatable carrier assembly positioned within the vertical portion and the rotatable carrier assembly including a substantially disc-like platform over which the material is positioned and a substantially plate-like platform which, when pushed against the disc-like platform, holds the material in place so that during spinning the disc-like platform and the plate-like platform rotate as a unit. The device further including a rotatable member positioned within the vertical portion and configured to be detachably attached to the base portion so as to engage and rotate the rotatable carrier assembly about the spinning axis thereby allowing a coloring agent applied to the material to spread under the action of the centrifugal force.

A system for creating a design on a material, the system including a device to spin the material so that a design is generated on the material under the action of a centrifugal force, the device including a housing including a base portion and a substantially vertical portion formed integral with the base portion, the base portion including one or more recesses in an upper surface thereof, the recesses being configured to respectively receive a rotating mechanism which is configured to engage and rotate the rotatable member around a spinning axis, and one or more power sources configured to power the rotating mechanism, the substantially vertical portion having an opening therethrough. The device also including a rotatable carrier assembly positioned within the vertical portion and the rotatable carrier assembly including a substantially disc-like platform to hold the material, and a substantially plate-like platform which, when pushed against the disc-like platform, holds the material in place so that during spinning, the disc-like platform and the plate-like platform rotate as a unit. The device further including a rotatable member positioned within the vertical portion and configured to be detachably attached to the base portion so as to engage and rotate the rotatable carrier assembly about the spinning axis, thereby allowing a coloring agent applied to the material to spread under the action of the centrifugal force. The system also including a lifting device configured to disengage the rotatable carrier assembly from the rotatable member and remove the rotatable carrier assembly from the device after spinning, and a disassembling device configured to separate the disc-like platform from the plate-like platform after the rotatable carrier assembly has been removed from the device.

A method of creating a design on a material by spreading a coloring agent applied to the material under the action of a centrifugal force, the method including positioning the material on a rotatable carrier assembly of a spinning machine so that a surface of the material being exposed for viewing and another surface of the material being secured to the rotatable carrier assembly so that the material stays stationary relative to the rotatable carrier assembly during spinning, the positioning the material on a rotatable carrier assembly including positioning the material on an upper surface of a disc-like platform so that a portion of the material is stretched over the upper surface of the disc-like platform, tucking the remaining material under the disc-like platform, and moving a plate-like platform toward a bottom surface of the disc-like platform until the material is secured in between the two platforms, the two platforms moving as a unit during spinning; spinning the rotatable carrier assembly around a spinning axis; and applying the coloring agent onto the exposed surface of the material during spinning.

A device for creating a design on a material, the device including a housing including a base portion and a contiguous and substantially vertical portion formed integral with and extending substantially vertically upwardly from around a top of the base portion, the base portion further including a bottom and a contiguous side wall extending substantially vertically upwardly from the bottom to merge with and around the top of the base portion, the base portion being substantially coaxially aligned with the vertical portion, the contiguous side wall including a plurality of substantially equally-spaced apart and curved protrusions extending outwardly and curving downwardly and away from the top of the base portion to the bottom of the base portion, and one or more recesses in the top of the base portion, at least one of the recesses being configured to receive a rotating mechanism configured to engage and rotate the rotatable member around a spinning axis, the substantially vertical portion having an opening therethrough. The device also including a rotatable carrier assembly positioned within the vertical portion and the rotatable carrier assembly including a substantially disc-like platform over which the material is positioned, the substantially disc-like platform including a substantially circular top plate with a contiguous and integrally connected and substantially cylindrically-shaped side wall depending downwardly and slightly outwardly from an outer circumferential edge of the top plate and a substantially plate-like platform which, when pushed against an interior of the substantially cylindrically-shaped side wall of the disc-like platform, holds the material in place so that during spinning the disc-like platform and the plate-like platform rotate as a unit. The device further including a rotatable member positioned within the vertical portion and being detachably attached to the base portion so as to engage and rotate the rotatable carrier assembly about the spinning axis thereby allowing a coloring agent applied to the material to spread under the action of a centrifugal force.

It is therefore, apparent that there is provided, in accordance with the present disclosure, a spinning assembly and method for creating wearable spin art, and a lifting and disassembling device to safely remove the painted material from the spinning assembly. Many alternatives, modifications, and variations are enabled by the present disclosure. Features of the disclosed embodiments can be combined, rearranged, omitted, etc. within the scope of the invention to produce additional embodiments.

Furthermore, certain features of the disclosed embodiments may sometimes be used to advantage without a corresponding use of other features. Accordingly, Applicant intends to embrace all such alternatives, modifications, equivalents, and variations that are within the spirit and scope of the present disclosure.

1. A device for creating a design on a material under the action of a centrifugal force, the device comprising:
a housing including a base portion and a substantially vertical portion formed integral with and extending substantially vertically upwardly from a top of the base portion, the base portion including one or more recesses in an upper surface thereof, at least one of the recesses being configured to receive a rotating mechanism configured to engage and rotate the rotatable member around a spinning axis, the substantially vertical portion having an opening therethrough;
a rotatable carrier assembly positioned within the vertical portion and the rotatable carrier assembly including a substantially disc-like platform over which the material is positioned and a substantially plate-like platform which, when pushed against the disc-like platform, holds the material in place so that during spinning the disc-like platform and the plate-like platform rotate as a unit; and
a rotatable member positioned within the vertical portion and configured to be detachably attached to the base portion so as to engage and rotate the rotatable carrier assembly about the spinning axis thereby allowing a coloring agent applied to the material to spread under the action of the centrifugal force.

2. The device of claim 1, wherein the plate-like platform includes a plurality of finger-like spiral members configured to hold the material against an inside surface of the disc-like platform and to keep the disc-like platform from detaching from the rotatable carrier assembly during spinning.

3. The device of claim 2, further including a friction enhancing member positioned on an inside surface of the disc-like platform to increase friction between the disc-like platform and the plate-like platform.

4. The device of claim 3, wherein the friction enhancing member includes one or more ridges and/or detents.

5. The device of claim 1, wherein the disc-like platform includes a substantially disc-like surface and a substantially circular side skirt positioned around a periphery of the disc-like surface to form a cavity underneath the surface.

6. The device of claim 5, wherein the side skirt is formed integral with the disc-like surface and further includes one or more indents along its perimeter.

7. The device of claim 6, wherein the side skirt further includes a plurality of grooves positioned at predetermined distances along a length of the side skirt so as to separate the side skirt into a plurality of flexible side skirt sections.

8. The device of claim 1, wherein the plate-like platform includes an opening in an upper surface thereof so that an elongated funnel-like plate connecting member formed integrally with the upper surface of the plate-like platform establishes a conduit through the plate-like platform.

9. The device of claim 8, wherein the plate-like platform further includes a continuous indent around the opening to allow the plate-like platform to snugly fit against the disc-like platform.

10. The device of claim 8, wherein the disc-like platform includes an integrally formed elongated funnel-like disc connecting member which establishes a conduit through the disc-like platform.

11. The device of claim 10, wherein the disc connecting member is configured to fit through the opening in the upper surface of the plate-like platform and through the plate connecting member so that the disc connecting member engages with the rotatable member.

12. The device of claim 11, wherein the disc connecting member is configured to snugly receive the rotatable member.

13. The device of claim 12, wherein an inside surface of the rotatable member includes a plurality of corrugations and an outside surface of the disc connecting member includes corresponding corrugations for snug engagement with each other.

14. The device of claim 1, wherein the rotating mechanism includes a motor and a motor shaft positioned in the recess.

15. The device of claim 14, wherein the rotating mechanism further includes a securing member attached to the motor shaft and configured to engage the rotatable member.

16. The device of claim 15, further including a cover member to cover the recess containing the motor and the motor shaft, the cover member including an opening through which the securing member engages the rotatable member.

17. The device of claim 16, wherein the other recesses are configured to receive one or more power sources, respectively, the motor being connected to one or more of the power sources.

18. The device of claim 17, further including one or more cover members to cover upper surfaces of respective recesses containing the power sources, the cover members being positioned so as to be flush with the upper surface of the base portion of the housing.

19. The device of claim 18, wherein the one or more power sources are batteries.

20. The device of claim 19, further including a switching device to activate the motor.

21. The device of claim 20, wherein the motor is activated remotely.

22. The device of claim 1, wherein the base portion further includes one or more protruding members formed integrally with the base portion, the protruding members being shaped so as to stabilize the device during the spinning operation.

23. The device of claim 22, wherein the base portion further includes a plurality of receptacles formed integral with the base portion configured to hold containers containing the coloring agents.

24. The device of claim 1, further comprising one or more lighting devices positioned on an inside and/or outside portion of the housing.

25. The device of claim 24, further comprising one or music playing devices positioned on an inside and/or outside portion of the housing.

26. The device of claim 1, further comprising a disposable lining member positioned snugly around an inside surface of the vertical portion of the housing and configured to protect the inside of the housing from being splashed with the coloring agent during spinning.

27. The device of claim 26, wherein the disposable lining member is configured to be removed from the housing after the spinning operation is completed, and is made of a material that allows the coloring agent to be washed off.

28. The device of claim 1, further comprising a lid member pivotally attached to an upper surface of the substantially vertical portion of the housing and configured to be pivoted between an open position and a closed position to protect the user from being splashed with the coloring agent during the spinning operation.

29. The device of claim 28, wherein the lid member includes an opening therethrough so that the coloring agent can be applied to the material during the spinning operation while the lid member is in the closed position.

30. The device of claim 1, further including a drying mechanism positioned on an inside and/or outside portion of the housing and configured to dry the material after the spinning operation is completed.

31. The device of claim 1 used to create a design on an article of clothing.

32. The device of claim 30, wherein the article of clothing includes T-shirts, caps, pants, skirts, and headwear.

33. The device of claim 31, wherein the coloring agent includes paint.

34. A system for creating a design on a material, comprising:
a device to spin the material so that a design is
generated on the material under the action of a centrifugal force, the device comprising:
a housing including a base portion and a
substantially vertical portion formed integral with the base portion, the base portion including one or more recesses in an upper surface thereof, the recesses being configured to respectively receive a rotating mechanism which is configured to engage and rotate the rotatable member around a spinning axis, and one or more power sources configured to power the rotating mechanism, the substantially vertical portion having an opening therethrough;
a rotatable carrier assembly positioned within the vertical portion and the rotatable carrier assembly including a substantially disc-like platform to hold the material, and a substantially plate-like platform which, when pushed against the disc-like platform, holds the material in place so that during spinning, the disc-like platform and the plate-like platform rotate as a unit;
a rotatable member positioned within the vertical portion and configured to be detachably attached to the base portion so as to engage and rotate the rotatable carrier assembly about the spinning axis, thereby allowing a coloring agent applied to the material to spread under the action of the centrifugal force;
a lifting device configured to disengage the rotatable carrier assembly from the rotatable member and remove the rotatable carrier assembly from the device after spinning; and
a disassembling device configured to separate the disc-like platform from the plate-like platform after the rotatable carrier assembly has been removed from the device.

35. The system of claim 34, wherein the plate-like platform includes a plurality of finger-like spiral members configured to hold the material against an inside surface of the disc-like platform and to keep the disc-like platform from detaching from the rotatable carrier assembly during spinning.

36. The system of claim 35, further including a friction enhancing member positioned on an inside surface of the disc-like platform to increase friction between the disc-like platform and the plate-like platform.

37. The system of claim 36, wherein the friction enhancing member includes one or more ridges and/or detents.

38. The system of claim 34, wherein the disc-like platform includes a substantially disc-like surface and a substantially circular side skirt positioned around a periphery of the disc-like surface to form a cavity underneath the surface.

39. The system of claim 38, wherein the side skirt is formed integral with the disc-like surface and further includes one or more indents along its perimeter.

40. The system of claim 39, wherein the side skirt further includes a plurality of grooves positioned at predetermined distances along a length of the side skirt so as to separate the side skirt into a plurality of flexible side skirt sections.

41. The system of claim 34, wherein the plate-like platform includes an opening in an upper surface thereof so that an elongated funnel-like plate connecting member formed integrally with the upper surface of the plate-like platform establishes a conduit through the plate-like platform.

42. The system of claim 41, wherein the plate-like platform further includes a continuous indent around the opening to allow the plate-like platform to snugly fit against the disc-like platform.

43. The system of claim 41, wherein the disc-like platform includes an integrally formed elongated funnel-like disc connecting member which establishes a conduit through the disc-like platform.

44. The system of claim 43, wherein the disc connecting member is configured to fit through the opening in the upper surface of the plate-like platform and slide through the plate connecting member to engage the rotatable member.

45. The system of claim 44, wherein the disc connecting member is configured to snugly receive the rotatable member.

46. The system of claim 45, wherein an inside surface of the rotatable member includes a plurality of corrugations and an outside surface of the disc connecting member includes corresponding corrugations for snug engagement with each other.

47. The system of claim 46, wherein the rotating mechanism includes a motor and a motor shaft positioned in the recess.

48. The system of claim 47, wherein the rotating mechanism further includes a securing member attached to the motor shaft and configured to engage the rotatable member.

49. The system of claim 48, further including a cover member to cover the recess containing the motor and the motor shaft, the cover member including an opening through which the securing member engages the rotatable member.

50. The system of claim 49, further including one or more cover members to cover upper surfaces of respective recesses containing the power sources, the cover members being positioned so as to be flush with the upper surface of the base portion of the housing.

51. The system of claim 34, wherein the lifting device includes a plurality of arm members detachably attached to each other at one end, and having respective free ends slightly bent so as to form a claw shaped lifting mechanism, the claw shaped lifting mechanism being configured to be attached to a bottom portion of the disc-like platform.

52. The system of claim 51, wherein the arm members are attached to each other in such a way as to allow one arm member to pivot in a vertical direction relative to the other arm members.

53. The system of claim 34, wherein the lifting device includes a movable member positioned within the vertical member and detachably attached to the upper surface of the base portion so as to be substantially perpendicular to the upper surface and so as to extend along a direction parallel to the spinning axis, the movable member being configured to move to different positions (heights) along the axis.

54. The system of claim 53, wherein the movable member is configured to move toward a bottom surface of the plate-like platform and push the bottom surface in an upward motion so as to disengage the rotatable carrier assembly including the two platforms from the rotatable member.

55. The system of claim 54, wherein an upper portion of the movable member is shaped so as to hold the rotatable carrier assembly after the rotatable carrier assembly is disengaged from the rotatable member.

56. The system of claim 55, wherein the movable member includes one or more telescopic rods.

57. The system of claim 55, wherein the movable member is connected to a moving mechanism which when activated via an on/off switch and/or a pedal-like mechanism, it moves the movable member in a vertical direction along the spinning axis.

58. The system of claim 34, wherein the disassembling device includes a substantially circular base member and a substantially cylindrical vertical member attached to the base member, the vertical member being configured to securely hold the rotatable carrier assembly after the rotatable carrier assembly is disengaged and removed from the spinning device.

59. The system of claim 58, wherein a top portion of the vertical member is shaped so as to allow the disc connecting member to slide into the vertical member until the top portion of the vertical member fits in between the disc connecting member and the plate connecting member.

60. The system of claim 59, wherein the vertical portion is further configured to allow the plate-like platform to move in a downward direction along a length of the vertical member away from the disc-like platform until the material is freed.

61. A method of creating a design on a material by spreading a coloring agent applied to the material under the action of a centrifugal force, the method comprising:
positioning the material on a rotatable carrier assembly of a spinning machine so that a surface of the material being exposed for viewing and another surface of the material being secured to the rotatable carrier assembly so that the material stays stationary relative to the rotatable carrier assembly during spinning, the positioning the material on a rotatable carrier assembly including positioning the material on an upper surface of a disc-like platform so that a portion of the material is stretched over the upper surface of the disc-like platform, tucking the remaining material under the disc-like platform, and moving a plate-like platform toward a bottom surface of the disc-like platform until the material is secured in between the two platforms, the two platforms moving as a unit during spinning;
spinning the rotatable carrier assembly around a spinning axis; and
applying the coloring agent onto the exposed surface of the material during spinning.

62. (canceled)

63. The method of claim 61, further comprising removing the rotatable carrier assembly holding the material from the spinning device after the spinning.

64. The method of claim 63, wherein the removing includes attaching a lifting device to the rotatable carrier assembly and moving the lifting device holding the rotatable carrier assembly away from the spinning device, the lifting device including a plurality of arm members detachable attached to each other at one end and with slightly inward bent free ends at respective other ends, the bent free ends forming together a claw-like mechanism, one of the arm members being configured to move in a vertical direction relative to the other arm members.

65. The method of claim 64, wherein the attaching the lifting device includes attaching the claw-like arm members to a bottom portion of the disc-like platform, and the moving includes lifting the lifting device by its attached ends away from the spinning device.

66. The method of claim 65, further comprising removing the material from the rotatable carrier assembly, the removing including positioning the rotatable carrier assembly using the lifting device on a disassembling device, detaching the lifting device from the rotatable carrier assembly, moving the plate-like platform away from the disc-like platform until the tucked away portion of the material is freed, and lifting the material away from the disc-like platform.

67. The method of claim 66, further comprising drying the material.

68. The method of claim 63, wherein the removing includes activating a moving member detachably attached to an inside portion of the spinning device to move upward in a vertical direction toward a bottom portion of the plate-like platform and push the rotatable carrier assembly including the two platforms away from the spinning device.

69. The method of claim 68, further including moving the plate-like platform away from the disc-like platform until the tucked away portion of the material is freed, and lifting the material away from the disc-like platform.

70. The method of claim 69, further including drying the material.

71. The method of claim 61, wherein the material is an article of clothing.

72. (canceled)

73. (canceled)

74. A device for creating a design on a material, the device comprising:
a housing including a base portion and a contiguous and substantially vertical portion formed integral with and extending substantially vertically upwardly from around a top of the base portion, the base portion further including a bottom and a contiguous side wall extending substantially vertically upwardly from the bottom to merge with and around the top of the base portion, the base portion being substantially coaxially aligned with the vertical portion, the contiguous side wall including a plurality of substantially equally-spaced apart and curved protrusions extending outwardly and curving downwardly and away from the top of the base portion to the bottom of the base portion, and one or more recesses in the top of the base portion, at least one of the recesses being configured to receive a rotating mechanism configured to engage and rotate the rotatable member around a spinning axis, the substantially vertical portion having an opening therethrough;
a rotatable carrier assembly positioned within the vertical portion and the rotatable carrier assembly including a substantially disc-like platform over which the material is positioned, the substantially disc-like platform including a substantially circular top plate with a contiguous and integrally connected and substantially cylindrically-shaped side wall depending downwardly and slightly outwardly from an outer circumferential edge of the top plate and a substantially plate-like platform which, when pushed against an interior of the substantially cylindrically-shaped side wall of the disc-like platform, holds the material in place so that during spinning the disc-like platform and the plate-like platform rotate as a unit; and
a rotatable member positioned within the vertical portion and being detachably attached to the base portion so as to engage and rotate the rotatable carrier assembly about the spinning axis thereby allowing a coloring agent applied to the material to spread under the action of a centrifugal force.
